(19) United States
(12) Patent Application Publication
(10) Pub. No.: US 2006/0236075 A1
(43) Pub. Date: Oct. 19, 2006

(54) SIMD microprocessor and data processing method

(76) Inventor: Kazuhiko Hara, Hyogo (JP)

Correspondence Address: DICKSTEIN SHAPIRO LLP, 1825 EYE STREET NW, Washington, DC, 20006-5403, US

(21) Appl. No.: 11/377,521

(22) Filed: Mar. 17, 2006

(30) Foreign Application Priority Data
Mar. 18, 2005 (JP) 2005-080548

(51) Int. Cl. G06F 15/00

(52) U.S. Cl. 712/22

(57) ABSTRACT

A SIMD microprocessor including m processor elements, m being a natural number that is no less than 2 is disclosed. The SIMD microprocessor includes an arithmetic part included in each processor element for processing a maximum of n data items in a single time by using n arithmetic circuits, n being a natural number that is no less than 2.

### BACKGROUND OF THE INVENTION

1. Field of the Invention

The present invention relates to an SIMD (Single Instruction-stream Multiple Data-stream) microprocessor using a single instruction for processing plural image data in parallel, and a data processing method using the SIMD microprocessor.

2. Description of the Related Art

Image data, which are handled by, for example, digital copiers, are generally a collection of data that are allocated two dimensionally. For example, in the image of a person shown in FIG. 13A, X data items (X is a natural number) are allocated in the horizontal direction, and Y data items (Y is a natural number) are allocated in the vertical direction. FIG. 13B is an enlarged view of the area surrounded by a broken line in FIG. 13A. The image shown in FIG. 13B has data items aligned in a grid-like manner. Each of the data items comprising the image is referred to as a pixel.

Each pixel is assigned a value. The content of each pixel is determined by its assigned value. For example, in a case where a pixel value of “1” represents black and a pixel value of “0” represents white, the image shown in FIG. 13B can be illustrated in a manner shown in FIG. 13C. Since the image shown in this example is illustrated with two colors (black and white), the pixels can be expressed by using two values. The image may, however, be expressed with a middle color(s) by assigning more values to the pixels. For example, by providing the pixel data as four bit data, each pixel can have 16 variations of data (from 0000 bits to 1111 bits). Thereby, a pixel can be provided 14 levels of middle colors between the colors of black and white. Furthermore, by providing the pixel data as eight bit data, each pixel can be expressed with 256 colors.

The sizes of pixel data are different depending on the purpose or the content of the image. For example, large bit data are provided for pixels of an image requiring exuberant expressions (e.g. a photograph), and small bit data are provided for pixels of an image requiring small data size (e.g. images used in communication).

Meanwhile, a SIMD microprocessor is often used as a microprocessor for processing images. This owes to the fact that the SIMD microprocessor has a characteristic that is suitable for image processing, in which the SIMD microprocessor can perform the same arithmetic process on plural data items with a single instruction at the same time. The SIMD microprocessor includes plural processor elements (hereinafter referred to as “PE”), in which each PE includes an arithmetic unit and a register. The plural PEs are used to perform the same arithmetic process at the same time; thereby, the same arithmetic process can be performed at the same time on plural data items with a single instruction. In processing an image by using the PEs, the PEs are usually configured so that each PE is assigned to process a single pixel of the image.

For example, as shown in FIG. 14, in a case where a SIMD microprocessor includes m PEs and the target image data in the horizontal direction includes (5×m) data items, a single alignment of pixels in the horizontal direction is divided into sets of m units and the sets are successively sent to the SIMD microprocessor. Accordingly, the SIMD microprocessor processes the pixels in m units. That is, as shown in FIG. 14, the SIMD microprocessor performs the same image process for five times on a single alignment since the pixels (5×m) are divided into five parts.

Next, an exemplary configuration of an SIMD microprocessor 2 according to a related art example is described with reference to FIG. 16. The SIMD microprocessor 2 roughly includes a global processor 30, a processor element group 72, and an external interface 70. The processor element group 72 includes an array (collection) of plural PEs. The arithmetic unit in each PE belongs to an arithmetic array 62, and the register in each PE belongs to a register file 60.

FIG. 15 is a schematic drawing showing the exemplary configuration of the SIMD microprocessor of the related art example in more detail. FIG. 15 mainly shows six PEs 4 provided at the center portion of the processor element group 72. The part indicated with reference numeral 4 corresponds to a single PE. Although each PE 4 is provided with 32 registers (6, 8), six registers are illustrated in the upper part of FIG. 15. The group of registers in the PE is referred to as a register file. A data bus 10 for reading/writing data from/to the registers is connected to a lower part (in FIG. 15) of the PE 4 via a multiplexer (7 to 1 MUX) and a shifter (Shift Expand) 16. The lower part of the PE 4 is provided with a 16 bit ALU 18 serving as an arithmetic unit, an A register 20 for storing arithmetic results therein, and an F register 22.

The multiplexer (7 to 1 MUX) 12 performs data connection between an ALU 18 of a given PE and a register(s) (6, 8) of a neighboring PE(s). In the exemplary configuration shown in FIG. 15, a single 16 bit ALU 18 can be connected to the registers (6, 8) of three neighboring PEs 4. The shifter (Shift Expand) 16 is situated between the register (6,8) and the ALU 18 for performing bit shifting of data. Among the registers (6, 8) in the PEs 4, the registers 6 that are connected to the external interface 70 (three registers in FIG. 15) perform reading and writing of data with the external interface 70 via a bus.

The right portion of FIG. 15 shows the global processor 30. The global processor 30 is an independent processor for reading and executing a program(s) and is also a controller for instructing respective PEs 4. The global processor 30 includes various registers G0, G1, G2, G3, SP, PC, LS, LI, LN, and P, a Program-RAM for storing programs, and a Data-RAM for temporarily storing data.

The demands regarding the functions of image processing are mainly aimed in two directions; one is increasing of processing speed and the other is improving image quality. There are two ways to increase the speed of processing images with the SIMD microprocessor. One is to increase the operating frequency of the processor and the other is to increase the number of pixels that can be processed in a single time. The former is in constant demand and it is difficult to improve performance in compliance with new demands. The latter typically requires an increase in the number of PEs. However, such increase of PEs leads to problems such as oversized circuits and degrading of operating frequency.

Meanwhile, in order to improve image quality, increase of colors and gradation is required for pixels. This leads to an undesired increase in the size of pixel data. For example, the pixel data size increases from eight bits (256 scale) to sixteen bits (65536 scale). Accordingly, such increase of pixel data size leads to an increase of the arithmetic unit capability in each PE.

Hence, there is demand to increase the number of PEs and increase the arithmetic data size of the PE in SIMD processors.

In one related art example, an SIMD microprocessor is provided with a floating point inner product arithmetic unit (See Japanese Laid-Open Patent Application No. 2001-256199).

### SUMMARY OF THE INVENTION

It is a general object of the present invention to provide a SIMD microprocessor and a data processing method that substantially obviates one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a SIMD microprocessor and a data processing method particularly pointed out in the specification in such full, clear, concise, and exact terms as to enable a person having ordinary skill in the art to practice the invention.

To achieve these and other advantages and in accordance with the purpose of the invention, as embodied and broadly described herein, the present invention provides a SIMD microprocessor including m processor elements, m being a natural number that is no less than 2, the SIMD microprocessor having: an arithmetic part included in each processor element for processing a maximum of n data items in a single time by using n arithmetic circuits, n being a natural number that is no less than 2.

Furthermore, the present invention provides a SIMD microprocessor including m processor elements, m being a natural number that is no less than 2, each processor element including a plurality of registers for temporarily storing data, an arithmetic part, and a path for transferring data between the plural registers and the arithmetic part, the SIMD microprocessor having: n arithmetic circuits in each arithmetic part for processing a maximum of n data items in a single time in each processor element, n being a natural number that is no less than 2; wherein the m processor elements are arranged with a predetermined alignment, wherein the n arithmetic circuits are arranged in predetermined positions in each processor element; wherein in a case of processing consecutive data items at the same time, the order for processing the data items with (m×n) arithmetic circuits is determined according to the predetermined positions of the arithmetic circuits in each processor element with reference to the predetermined alignment of the processor elements.

In the SIMD microprocessor according to an embodiment of the present invention, the arithmetic circuit may include a data transfer path for transferring data to a register provided in the same processor element as the arithmetic circuit and to another register provided in a neighboring processor element, wherein the data transfer path transfers neighboring data in a consecutive data item to be processed at the same time.

Furthermore, the present invention provides a SIMD microprocessor including m processor elements, m being a natural number that is no less than 2, each processor element including a plurality of registers for temporarily storing data, an arithmetic part, and a path for transferring data between the plural registers and the arithmetic part, the SIMD microprocessor having: n arithmetic circuits in each arithmetic part for processing a maximum of n data items in a single time in each processor element, n being a natural number that is no less than 2; wherein the m processor elements are arranged with a predetermined alignment, wherein the n arithmetic circuits are arranged in predetermined positions in each processor element; wherein in a case of processing consecutive data items at the same time, the order for processing the data items with (m×n) arithmetic circuits is determined according to the predetermined alignment of the processor elements with reference to the predetermined positions of the arithmetic circuits in each processor element.

In the SIMD microprocessor according to an embodiment of the present invention, one arithmetic circuit may include a data transfer path for transferring data to a register provided in the same processor element as the arithmetic circuit and to another register provided in a neighboring processor element, wherein another arithmetic circuit provided in a processor element situated on one end of the predetermined alignment of processor elements includes a data transfer path for transferring data to yet another register provided in a processor element situated on the other end of the predetermined alignment of processor elements, wherein the data transfer paths transfer neighboring data in a consecutive data item to be processed at the same time.

In the SIMD microprocessor according to an embodiment of the present invention, each arithmetic circuit may include a bit shift apparatus for setting different bit shift amounts in accordance with the predetermined positions of the arithmetic circuits in each processor element.

Furthermore, the present invention provides a method for processing data by using an SIMD microprocessor including m processor elements, m being a natural number that is no less than 2; each processor element including a plurality of registers for temporarily storing data, an arithmetic part, and a path for transferring data between the plural registers and the arithmetic part, the arithmetic part including n arithmetic circuits for processing a maximum of n data items in a single time in the arithmetic part, n being a natural number that is no less than 2, the method having the steps of: determining the alignment for arranging the m processor elements; determining the positions for arranging the n arithmetic circuits in each processor element; and processing consecutive data items at the same time by determining the order for processing the data items with (m×n) arithmetic circuits according to the predetermined positions of the n arithmetic circuits in each processor element with reference to the predetermined alignment of the processor elements.

In the data processing method according to an embodiment of the present invention, the data processing method may further include a step of: transferring data to a register provided in the same processor element as the arithmetic circuit and to another register provided in a neighboring processor element via a data transfer path provided in the arithmetic circuit, wherein the data transfer path transfers neighboring data in a consecutive data item to be processed at the same time.

Furthermore, the present invention provides a method for processing data by using a SIMD microprocessor including m processor elements, m being a natural number that is no less than 2, each processor element including a plurality of registers for temporarily storing data, an arithmetic part, and a path for transferring data between the plural registers and the arithmetic part, the arithmetic part including n arithmetic circuits for processing a maximum of n data items in a single time in the arithmetic part, n being a natural number that is no less than 2, the method having the steps of: determining the alignment for arranging the m processor elements; determining the positions for arranging the n arithmetic circuits in each processor element; and processing consecutive data items at the same time by determining the order for processing the data items with (m×n) arithmetic circuits according to the predetermined alignment of the processor elements with reference to the predetermined positions of the n arithmetic circuits in each processor element.

In the data processing method according to an embodiment of the present invention, the data processing method may further include the steps of: transferring data to a register provided in the same processor element as the arithmetic circuit and to another register provided in a neighboring processor element via a data transfer path provided in one arithmetic circuit; and transferring data to yet another register provided in a processor element situated on one end of the predetermined alignment of processor elements via a data transfer path provided in another arithmetic circuit provided in a processor element situated on the other end of the predetermined alignment of processor elements, wherein the data transfer paths transfer neighboring data in a consecutive data item to be processed at the same time.

In the data processing method according to an embodiment of the present invention, the data processing method may further include a step of: setting different bit shift amounts in accordance with the predetermined positions of the arithmetic circuits in each processor element by using a bit shift apparatus.

Other objects and further features of the present invention will be apparent from the following detailed description when read in conjunction with the accompanying drawings.

### BRIEF DESCRIPTION OF THE DRAWINGS

FIG. 1 is a schematic drawing showing an exemplary configuration of an SIMD microprocessor according to the first embodiment of the present invention;

FIG. 2 is a schematic drawing showing an exemplary configuration of a SIMD microprocessor according to the second embodiment of the present invention;

FIG. 3 is a schematic drawing showing an exemplary configuration of a SIMD microprocessor according to the third embodiment of the present invention;

FIG. 4 is a schematic drawing showing an exemplary configuration of an SIMD microprocessor according to the fourth embodiment of the present invention;

FIG. 5 is a schematic drawing with a right part showing an arrangement of pixels of an image data item and a left part showing a first alignment pattern of pixels in an SIMD microprocessor according to an embodiment of the present invention;

FIG. 6 is a schematic drawing with a right part showing an arrangement of pixels of an image data item and a left part showing a second alignment pattern of pixels in an SIMD microprocessor according to an embodiment of the present invention;

FIG. 7 is a schematic drawing with a right part showing an arrangement of pixels of an image data item and a left part showing a third alignment pattern of pixels in an SIMD microprocessor according to an embodiment of the present invention;

FIG. 8 is a schematic drawing with a right part showing an arrangement of pixels of an image data item and a left part showing a fourth alignment pattern of pixels in an SIMD microprocessor according to an embodiment of the present invention;

FIG. 9 is a schematic drawing with a right part showing an arrangement of pixels of an image data item and a left part showing a fifth alignment pattern of pixels in an SIMD microprocessor according to an embodiment of the present invention;

FIG. 10 is a schematic drawing for describing that a process is to be repeated five times for processing all 480 pixels arranged in the horizontal direction of an image data item, in a case where the number of pixels (pixel data) that can be processed by a SIMD microprocessor in a single time is 96 pixels and the process creates no invalid pixels on either end of the pixel array;

FIG. 11 is a schematic drawing for describing that a process is to be repeated eight times for processing all 480 pixels arranged in the horizontal direction of an image data item, in a case where the number of pixels (pixel data) that can be processed by a SIMD microprocessor in a single time is 96 pixels and the pixel array includes 16 invalid pixels on each end of the pixel array;

FIG. 12 is a schematic drawing for describing that a process is to be repeated three times for processing all 480 pixels arranged in the horizontal direction of an image data item, in a case where the number of pixels (pixel data) that can be processed by a SIMD microprocessor in a single time is 192 pixels and the pixel array includes 16 invalid pixels on each end of the pixel array;

FIG. 13A is a schematic drawing showing an exemplary image of a person;

FIG. 13B is a schematic drawing showing an enlarged view of a portion of the exemplary image of a person in FIG. 13A;

FIG. 13C is a schematic drawing showing an example of image data (image data item);

FIG. 14 is a schematic drawing showing an exemplary configuration of image data (image data item);

FIG. 15 is a schematic drawing showing an exemplary configuration of an SIMD microprocessor according to a related art example; and

FIG. 16 is a schematic drawing showing another exemplary configuration of an SIMD microprocessor according to a related art example.

### DESCRIPTION OF THE PREFERRED EMBODIMENTS

In the following, embodiments of the present invention are described with reference to the accompanying drawings.

### First Embodiment

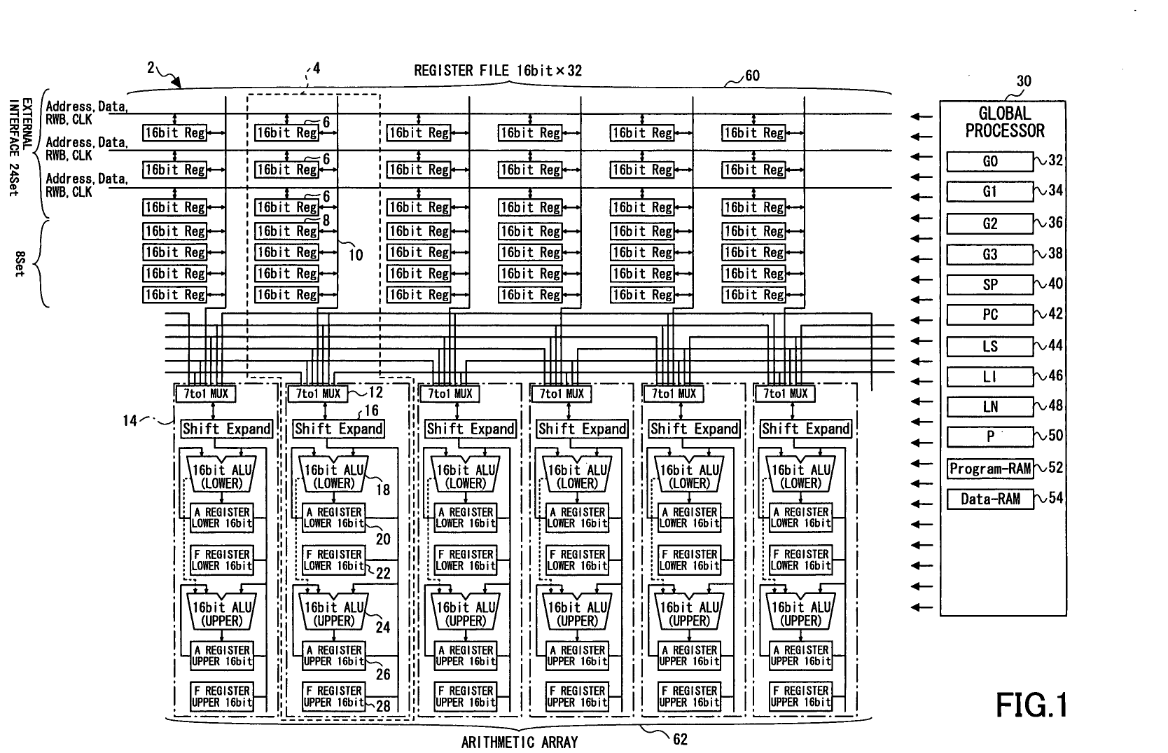

FIG. 1 is a schematic drawing showing an exemplary configuration of a SIMD microprocessor 2 according to the first embodiment of the present invention. The SIMD microprocessor 2 includes, for example, a global processor 30, a processor element group 72, and an external interface 70.

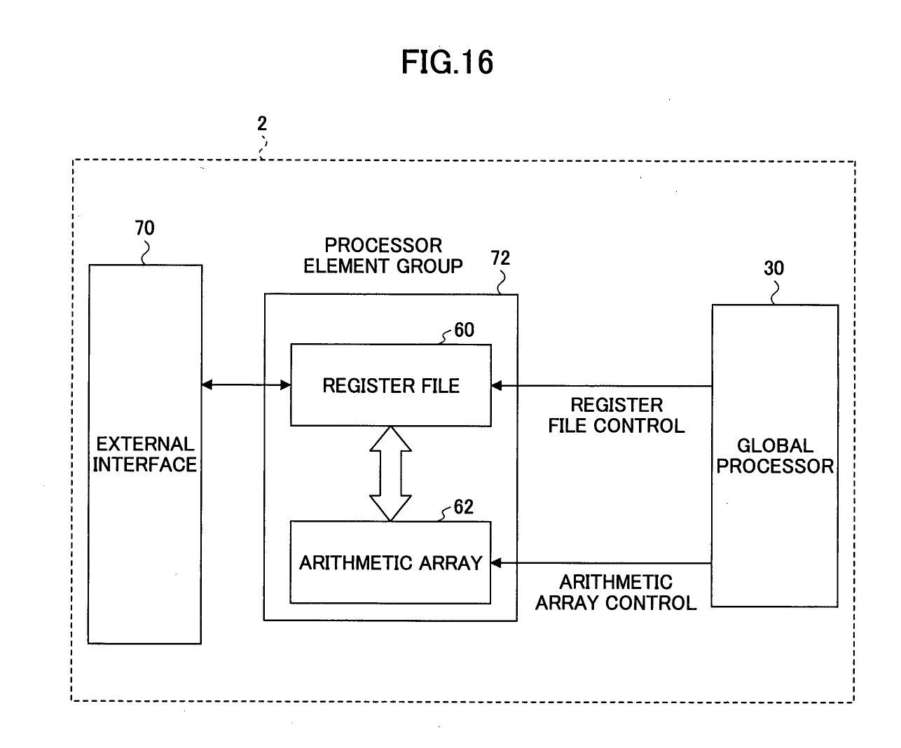

FIG. 1 mainly shows six PEs 4 that are provided at the center portion of the processor element group 72 (See FIG. 16). The global processor 30 shown on the right part of FIG. 1 includes a program RAM 52 for storing programs therein and a data RAM 54 for storing arithmetic data therein. Furthermore, the global processor 30 also includes: a program counter (PC) 42 containing the address(es) of a program(s); G0-G3 registers (32, 34, 36, 38) which are general purpose registers (G0-G3) for storing data of an arithmetic process; a stack pointer (SP) 40 for containing the address(es) of migration destination data RAM upon migration/return of a register; a link register (LS) 44 for containing the address(es) of a call source upon subroutine call; an LI register 46 and LN register 48 for containing the address of a branch source upon IRQ (Interrupt Request) or an NMI (Non Maskable Interrupt); and a processor status register (P) 50 for containing the status of a processor. The instructions of the global processor 30 are executed by using these registers, an instruction decoder (not shown), an ALU (not shown), a memory control circuit (not shown), an interruption control circuit (not shown), an external I/O control circuit (not shown), and a GP arithmetic control circuit (not shown).

In executing the instructions of the PE, the global processor 30 controls the register file 60 and the arithmetic array 62 of the PE by using a register file control circuit (not shown) and a PE arithmetic control circuit (not shown).

In the register file 60, each PE includes plural 16 bit registers (6, 8) which are arranged in groups corresponding to the number of PEs, to thereby form an array configuration. Each register (6, 8) is provided with a port for the arithmetic array 62. The arithmetic array 62 accesses the registers (6, 8) via a 16 bit read/write bus (hereinafter referred to as “register bus”). For the sake of convenience, FIG. 1 shows each PE 4 having seven registers (6, 8).

Each of the PEs 4 has an arithmetic part 14 that includes two sets of a 16 bit ALU (18, 24), a 16 bit A register (20, 26), and a F register (22, 28). One set is for processing upper bit data (high order data) and the other set is for processing lower bit data (low order data). In an arithmetic process by a PE instruction, the data read out from the register file 60 is input to one ALU (18, 24) and the data inside the A register (20, 26) is input to the other ALU (18, 24). The arithmetic results are stored in the A register (20, 26). That is, an arithmetic process is performed with the data in the A register (20, 26) and the 16 bit register (6, 8).

Each of the two ALUs (18, 24) can perform a 16 bit arithmetic operation. Furthermore, the ALU 24 for upper bit data and the ALU 18 for lower bit data are configured to cooperate with each other. Accordingly, by combining the ALU 24 and the ALU 18, a 32 bit arithmetic operation can be achieved. Each ALU (18, 24) is controlled by the global processor 30. Furthermore, an information transmission path is provided between the ALU 18 and ALU 24 for performing the cooperative operation between the ALU 18 and the ALU 24.

A 7 to 1 multiplexer (7 to 1 MUX) 12 having a width of 16 bits is provided at the connection part between the 16 bit registers (6, 8) and the arithmetic part 14. Each of the 7 to 1 multiplexers 12 is connected to the register bus corresponding to its own PE 4 (primary PE) and the register buses corresponding to adjacent PEs that are aligned in the horizontal direction of FIG. 1. In this example, each of the 7 to 1 multiplexers 12 is connected to the register bus corresponding to its own PE (primary PE) 4, the register buses corresponding to the three PEs 4 (the first left PE 4, the second left PE 4, and the third left PE 4) aligned on its left side, and the register buses for the three PEs 4 (the first right PE, the second right PE 4, and the third right PE4) aligned on its right side. Accordingly, the data in the registers corresponding to the register buses are selected as the target to which the arithmetic operation is performed. The global processor 30 controls the selection of the arithmetic operation target.

A shifter (Shift Expand) 16 is provided between the 7 to 1 multiplexer 12 and the ALU (18, 24). The shifter 16 perform bit shift and bit expansion on the data read out from the 16 bit registers (6, 8). The global processor 30 controls the bit shift and bit expansion of the shifter 16.

The three upper registers 6 included in the register file 60 are registers to which reading/writing of data from an external memory data transfer apparatus (not shown) outside of the microprocessor 2 is performed.

Next, the operation of the SIMD microprocessor according to the first embodiment of the present invention (shown in FIG. 1) is described.

In the SIMD microprocessor 2 shown in FIG. 1, image data are transferred from outside via the external interface 70. The following examples describe a case where image data (pixel data) are already transferred from an external memory data transfer apparatus (not shown) to the registers 6 of each PE 4.

The first example describes a case where the data size of a pixel (pixel data size) is 16 bits. Since the data size of a pixel is 16 bits, the pixel data can be used to express a monochrome image or a color image in a highest quality level. It is to be noted that the data of a color image is normally expressed in the form of three primary colors (RGB type) or four complementary colors (CMYK type). Accordingly, image processing is performed by dividing data into respective colors.

Since the size of the 16 bit registers (6, 8) and the width of the path from the 16 bit registers (6, 8) to the ALU (18, 24) are 16 bits, 16 bit data can be satisfactorily transferred.

The shifter 16, positioned in between the registers (6, 8) and the ALU (18, 24), expands the transferred data to 32 bit length. The upper 16 bits of the expanded 32 bit data are guided to the upper bit ALU 24 and the lower 16 bits of the expanded 32 bit data are guided to the lower bit ALU 18. The guided data are referred to as “X data”.

The A registers (20, 26), which not only store arithmetic results therein but also serve as a source for supplying data to the ALU (18, 24), together supply 32 bit data to the ALU (18, 24). The supplied data are referred to as “Y data”. The ALU (18, 24), receiving the X data and the Y data, performs an arithmetic operation on the received data. In this arithmetic operation, the upper bit ALU 24 and the lower bit ALU 18 operate together as a single 32 bit arithmetic unit. Typically, in a case where two arithmetic units (each having a predetermined bit size) are used to perform an arithmetic operation on data that is twice the size of the predetermined bit size, signals are to be transmitted between the two arithmetic units. In this example, an information transmission path provided between the upper bit ALU 24 and the lower bit ALU 18 is used.

In the arithmetic operation performed on the X data and the Y data, the data subjected to the arithmetic operation are both 32 bit data. Accordingly, the arithmetic result also becomes 32 bit data. The upper 16 bits of the arithmetic result are stored in the upper bit A register 26, and the lower 16 bits of the arithmetic result are stored in the lower bit A register 20. Thus, the A registers (26, 20) again become the sources for supplying data to the ALU (18, 24).

As described above, during the process of performing the arithmetic operation, the data subjected to the arithmetic operation become 32 bits. Therefore, in returning the resultant 32 bit data to the register file 60, the 32 bit data are formatted to 16 bit data and returned to the register file 60 as 16 bit data. In this example, the formatting is performed by bit shifting the 32 bit data and using only the lower 16 bits.

In a case of executing an image process, such as a filter process, there is sometimes a need to obtain data of a neighboring pixel. The SIMD microprocessor 2 shown in FIG. 1 has the 7 to 1 multiplexer 12 provided at the connecting part between the registers (6, 8) and the arithmetic part 14 and is configured to select the first left PE 4, the second left PE 4, and the third left PE 4 or the first right PE 4, the second right PE 4, and the third right PE 4 (three adjacent PEs in the horizontal direction as shown in FIG. 1). By matching the alignment of the pixels and the alignment of the PEs beforehand, a neighboring (adjacent) PE will contain data of a neighboring (adjacent) pixel. Thereby, the arithmetic operation results of the arithmetic part 14 of each PE can be used for the data of an adjacent pixel.

The second example describes a case where the data size of a pixel (pixel data size) is 8 bits. Since the data size of a pixel is 8 bits, the pixel data can be used to express a monochrome image or a color image in an ordinary quality level.

In a case where the data size of a pixel is 8 bits, each PE 4 in the SIMD microprocessor 2 shown in FIG. 1 performs image processing on two pixels. First, two 8 bit data items are stored in the registers (6, 8). That is, in the 16 bit data size (16 bit data space) of each register (6, 8), data items of two pixels are separately stored in the upper 8 bit space and the lower bit space of the registers (6, 8). Since the width of the register bus 10 from the registers (6, 8) to the arithmetic part 14 is 16 bits, two 8 bit data items can be satisfactorily transferred to the arithmetic part 14. The shifter 16, positioned in between the registers (6, 8) and the ALU (18, 24), separates the two 8 bit data items and expands each 8 bit data item into a 16 bit data item. Thereby, the upper 16 bits are guided to the upper bit ALU 24 and the lower 16 bits are guided to the lower bit ALU 18. The upper 16 bit data item is referred to as “XH data”, and the lower 16 bit data item is referred to as “XL data”.

The A registers (20, 26), which not only store arithmetic results therein but also serve as a source for supplying data to the ALU (18, 24), supplies upper and lower 16 bit data to the ALU 18 and the ALU 24, respectively. The supplied upper data are referred to as “YH data”, and the supplied lower data are referred to as “YL data”. The lower ALU 18, receiving the XL data and the YL data, performs an arithmetic operation on the received data. The upper ALU 24, receiving the XH data and the YH data, performs an arithmetic operation on the received data. In this arithmetic operation, the upper bit ALU 24 and the lower bit ALU 18 each operates as an independent 16 bit arithmetic unit. In this case, an information transmission path provided between the upper bit ALU 24 and the lower bit ALU 18 is not used.

In the arithmetic operation performed on the XL data and the YL data and the arithmetic operation performed on the XH data and the YH data, the data subjected to the arithmetic operations are 16 bit data. Accordingly, the arithmetic result also becomes 16 bit data. The 16 bit data of the arithmetic result from the upper ALU 24 are stored in the upper bit A register 26, and the 16 bit data of the arithmetic result from the lower ALU are stored in the lower bit A register 20. Thus, the A registers (26, 20) again become the sources for supplying data to the ALU (18, 24).

As described above, during the process of performing the arithmetic operations, the data subjected to the arithmetic operation become 16 bits. Therefore, in returning the resultant 16 bit data to the register file 60, the 16 bit data are formatted to two 8 bit data items and returned to the register file 60 as two 8 bit data items. In this example, the formatting is performed by bit shifting the 16 bit data, using only the lower 8 bits, and combining the upper 8 bit data and the lower 8 bit data at the shifter 16, to thereby form a single 16 bit data item.

### Patterns of Pixel Alignment Used in Second to Fourth Embodiments of Present Invention

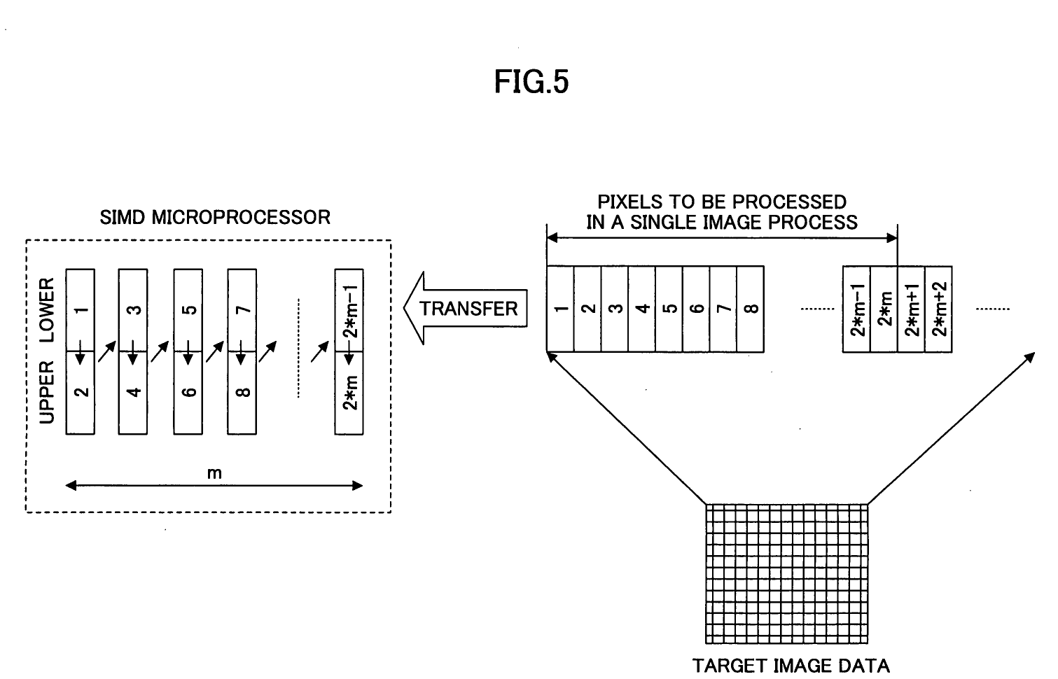

In a case of processing two pixels with a single PE in an SIMD microprocessor, there are various patterns for aligning the pixels in the PE. The following describes various patterns for aligning pixels in a PE. The configuration for enabling an arithmetic part of a given PE to use the data in a register of an adjacent or neighboring PE becomes different depending on the alignment of the pixels in the PE. Such differences of configuration are the differences among the below-described second to fourth embodiments of the present invention. The various patterns in the alignment of pixels in the PE are shown in FIGS. 5 to 9.

The right part of FIG. 5 shows the alignment of pixels of an image data item. The left part of FIG. 5 shows the first alignment pattern of pixels in an SIMD microprocessor according to an embodiment of the present invention. In this example, the SIMD microprocessor includes m PEs, in which a single PE can perform an arithmetic operation on two pixels. The left side of FIG. 5 schematically shows the pixels which are to be processed as upper side data in the PE and the pixels which are to be processed as lower side data in the PE. Since two pixels are processed in a single PE, the SIMD microprocessor can process (2×m) pixels at a single time. In the pixels of the image data shown in the right part of FIG. 5, (2×m) pixels that are consecutively aligned on the same line are transferred to the SIMD microprocessor and are subjected to an arithmetic operation by the SIMD microprocessor. In a case where the pixels of the image data are successively denoted as 1, 2, 3 . . . from the left to right direction, pixel 1 to pixel (2×m) are transferred to the SIMD microprocessor as pixels which are to be processed in a single image process.

In the SIMD microprocessor shown in FIG. 5, respective pixel data items of the target image data are aligned in the following manner. First, pixel 1 is arranged on the lower side of the first PE; then, pixel 2 is arranged on the upper side of the first PE; then, pixel 3 is arranged on the lower side of the second PE; then, pixel 4 is arranged on the upper side of the second PE; then, pixel 5 is arranged on the lower side of the third PE; then, pixel 6 is arranged on the upper side of the third PE; then, . . . ; then, pixel (2×m−1) is arranged on the lower side of the m^{th} PE; and then, pixel (2×m) is arranged on the upper side of the m^{th} PE. In a subsequent image process operation, the succeeding set of target image process pixels beginning from pixel (2×m+1) are transferred to the SIMD microprocessor.

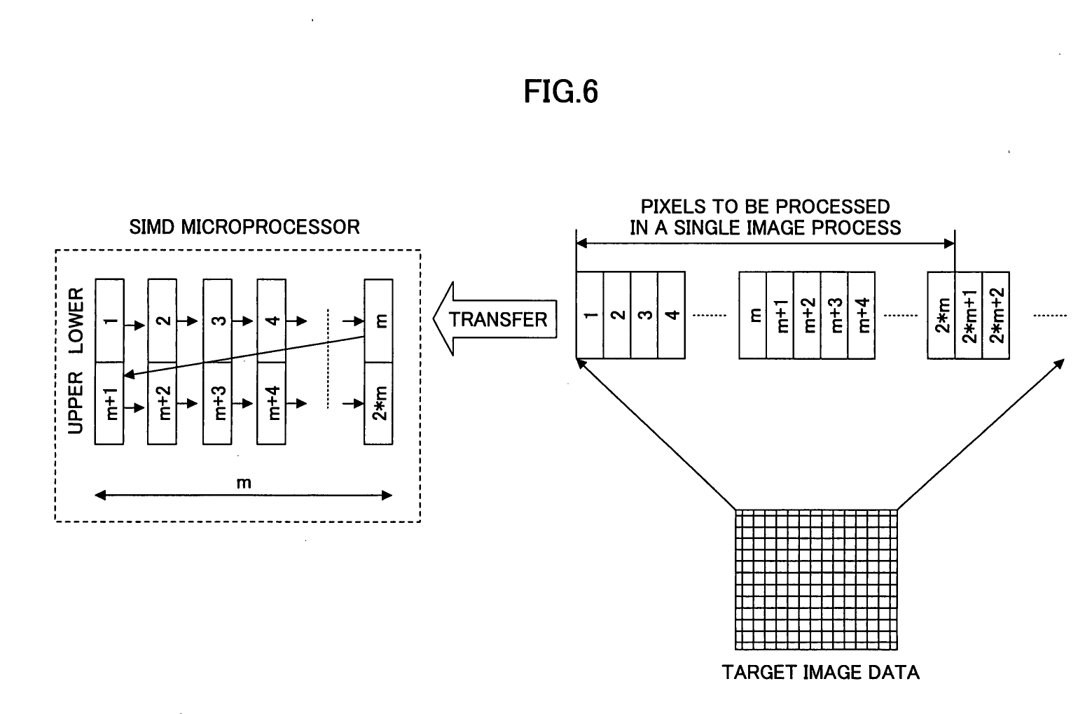

The right part of FIG. 6 shows the alignment of pixels of an image data item. The left part of FIG. 6 shows the second alignment pattern of pixels in an SIMD microprocessor according to an embodiment of the present invention.

In this example, the SIMD microprocessor includes m PEs, in which a single PE can perform an arithmetic operation on two pixels. The left side of FIG. 6 schematically shows the pixels which are to be processed as upper side data in the PE and the pixels which are to be processed as lower side data in the PE. Since two pixels are processed in a single PE, the SIMD microprocessor can process (2×m) pixels at a single time. In the pixels of the image data shown in the right part of FIG. 6, (2×m) pixels that are consecutively aligned on the same line are transferred to the SIMD microprocessor and are subjected to an arithmetic operation by the SIMD microprocessor. In a case where the pixels of the image data are successively denoted as 1, 2, 3 . . . from the left to right direction, pixel 1 to pixel (2×m) are transferred to the SIMD microprocessor as pixels which are to be processed in a single image process.

In the SIMD microprocessor shown in FIG. 6, respective pixel data items of the target image data are aligned in the following manner. First, pixel 1 is arranged on the lower side of the first PE; then, pixel 2 is arranged on the lower side of the second PE; then, pixel 3 is arranged on the lower side of the third PE; then, . . . ; then, pixel m is arranged on the lower side of the m^{th} PE; then, pixel (m+1) is arranged on the upper side of the first PE; then, pixel (m+2) is arranged on the upper side of the second PE; then, pixel (m+3) is arranged on the upper side of the third PE; then, . . . ; and then, finally pixel (2×m) is arranged on the upper side of the m^{th} PE. In a subsequent image process operation, the succeeding set of target image process pixels beginning from pixel (2×m+1) are transferred to the SIMD microprocessor.

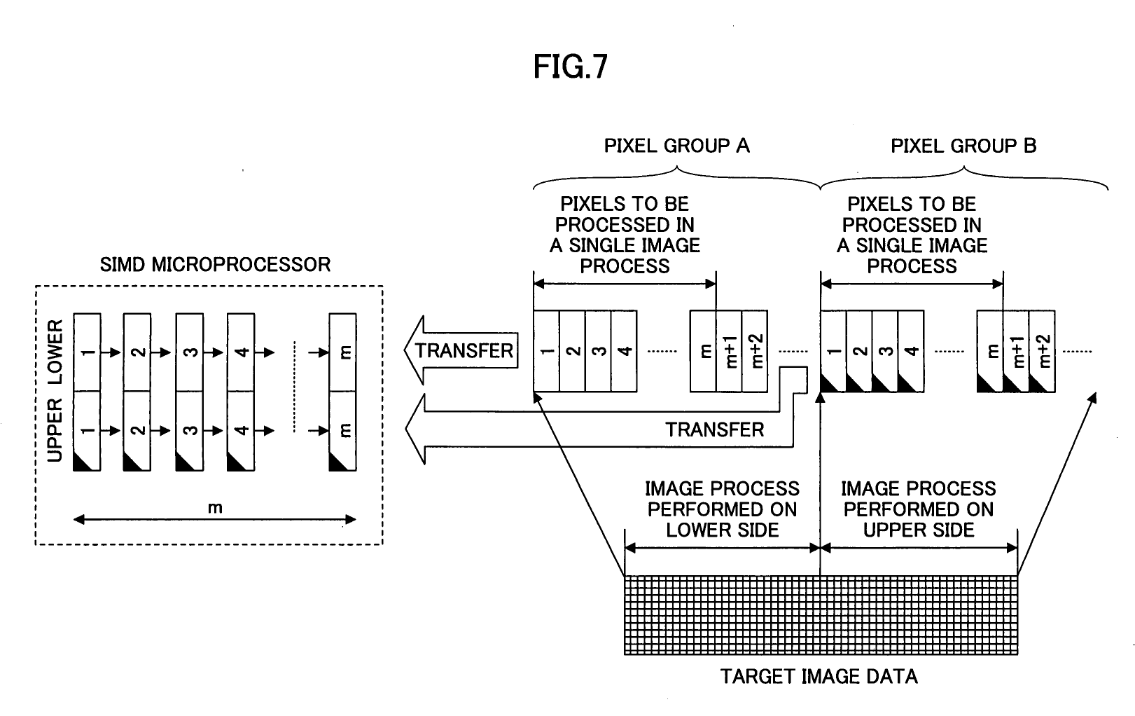

The right part of FIG. 7 shows the alignment of pixels of an image data item. The left part of FIG. 7 shows the third alignment pattern of pixels in a SIMD microprocessor according to an embodiment of the present invention.

In this example, the SIMD microprocessor includes m PEs, in which a single PE can perform an arithmetic operation on two pixels. The left side of FIG. 7 schematically shows the pixels which are to be processed as upper side data in the PE and the pixels which are to be processed as lower side data in the PE. Since two pixels are processed in a single PE, the SIMD microprocessor can process (2×m) pixels at a single time. In the pixels of the image data shown in the right part of FIG. 7, (2×m) pixels that are consecutively aligned on the same line are transferred to the SIMD microprocessor and are subjected to an arithmetic operation by the SIMD microprocessor. However, in this third alignment pattern shown in FIG. 7, two groups of consecutively aligned pixels (each group provided with m pixels) are transferred to the SIMD microprocessor. The consecutive pixels aligned in the image data, which are to be transferred to the SIMD processor, are divided into two groups beforehand (see Pixel Group A and Pixel Group B in right part of FIG. 7). In a case where the pixels of Pixel Group A are successively denoted as 1, 2, 3 . . . from the left to right direction and the pixels of Pixel Group B are successively denoted as 1, 2, 3 . . . from the left to right direction, pixel 1 to pixel m in each of the Pixel Groups A and B are transferred to the SIMD microprocessor as pixels which are to be processed in a single image process. In the left part of FIG. 7, the pixels of Pixel Group B are illustrated with black triangles to be distinguished from the pixels of Pixel Group A.

In the SIMD microprocessor shown in FIG. 7, the pixels (pixel data) of Pixel Group A are arranged on the lower side of respective PEs and the pixels (pixel data) of Pixel Group B are arranged on the upper side of respective PEs. With respect to the pixels in each pixel group, pixel 1 is arranged in the first PE; then, pixel 2 is arranged in the second PE; then, pixel 3 is arranged in the third PE; then, . . . ; and then, pixel m is arranged in the m^{th} PE. In a subsequent image process operation, the succeeding groups of target image process pixels beginning from pixel (m+1) in each group are transferred to the SIMD microprocessor.

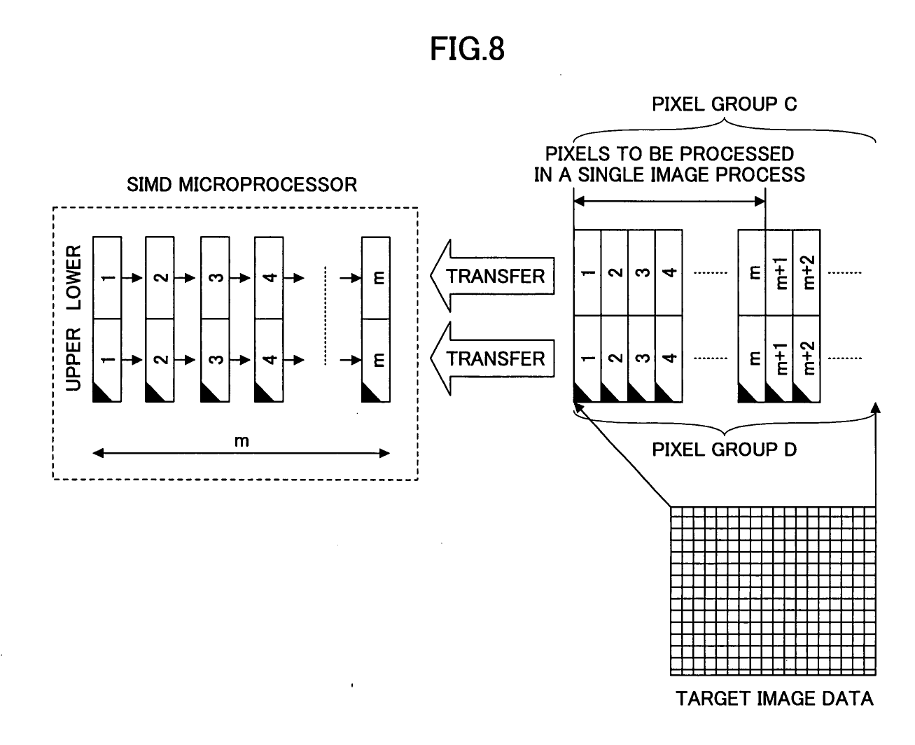

The right part of FIG. 8 shows the alignment of pixels of an image data item. The left part of FIG. 8 shows the fourth alignment pattern of pixels in a SIMD microprocessor according to an embodiment of the present invention.

In this example, the SIMD microprocessor includes m PEs, in which a single PE can perform an arithmetic operation on two pixels. The left side of FIG. 8 schematically shows the pixels which are to be processed as upper side data in the PE and the pixels which are to be processed as lower side data in the PE. Since two pixels are processed in a single PE, the SIMD microprocessor can process (2×m) pixels at a single time. In the pixels of the image data shown in the right part of FIG. 8, two groups of consecutively aligned pixels (each group provided with m pixels, total number of pixels of the two groups being (2×m) pixels) are transferred to the SIMD microprocessor and are subjected to an arithmetic operation by the SIMD microprocessor. However, in this fourth alignment pattern, while one group of pixels (Pixel Group C) includes m pixels that are consecutively aligned in one line of the image data, the other group of pixels (Pixel Group D) includes m pixels that are consecutively aligned in another line of the image data. In a case where the pixels of Pixel Group C are successively denoted as 1, 2, 3 . . . from the left to right direction and the pixels of Pixel Group D are successively denoted as 1, 2, 3 . . . from the left to right direction, pixel 1 to pixel m in each of the Pixel Groups C and D are transferred to the SIMD microprocessor as pixels which are to be processed in a single image process. In the left part of FIG. 8, the pixels of Pixel Group D are illustrated with black triangles to be distinguished from the pixels of Pixel Group C.

In the SIMD microprocessor shown in FIG. 8, the pixels (pixel data) of Pixel Group C are arranged on the lower side of respective PEs and the pixels (pixel data) of Pixel Group D are arranged on the upper side of respective PEs. With respect to the pixels in each pixel group, pixel 1 is arranged in the first PE; then, pixel 2 is arranged in the second PE; then, pixel 3 is arranged in the third PE; then, . . . ; and then, pixel m is arranged in the m^{th} PE. In a subsequent image process operation, the succeeding groups of target image process pixels beginning from pixel (m+1) in each group are transferred to the SIMD microprocessor. It is to be noted that the pixels of Pixel Group C and the pixels of Pixel Group D do not need to be pixels aligned in two adjacent lines of the image data.

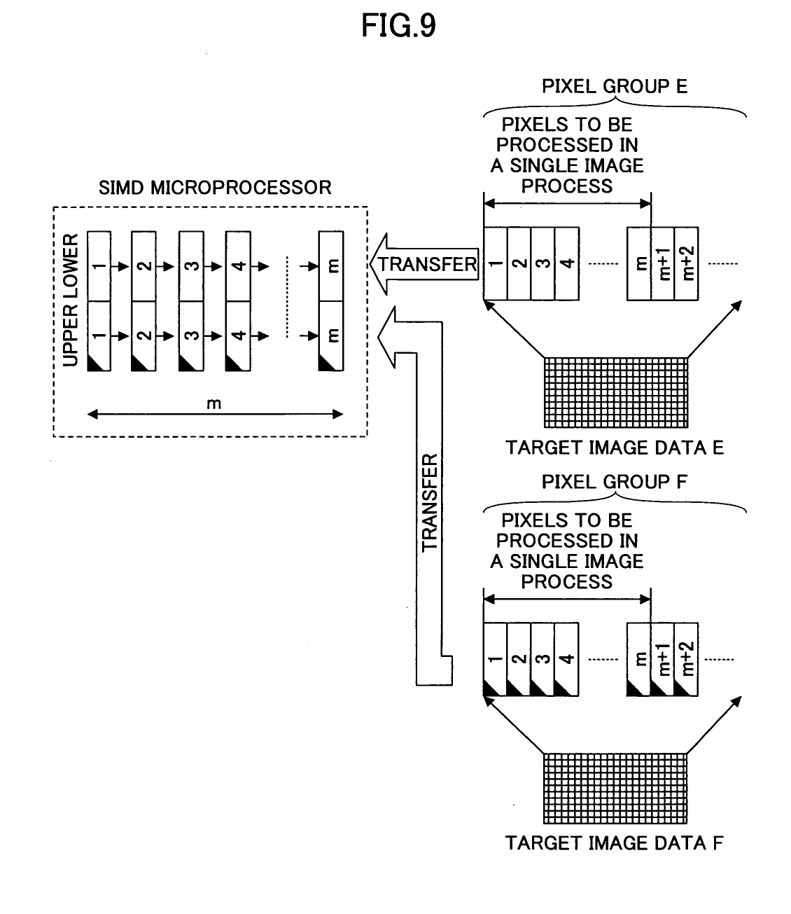

The right part of FIG. 9 shows the alignment of pixels of two image data items. The left part of FIG. 9 shows the fifth alignment pattern of pixels in a SIMD microprocessor according to an embodiment of the present invention.

In this example, the SIMD microprocessor includes m PEs, in which a single PE can perform an arithmetic operation on two pixels. The left side of FIG. 9 schematically shows the pixels which are to be processed as upper side data in the PE and the pixels which are to be processed as lower side data in the PE. Since two pixels are processed in a single PE, the SIMD microprocessor can process (2×m) pixels at a single time. In this fifth alignment pattern, the pixels which are to be transferred to the SIMD microprocessor are pixels included in two different image data items (image data item E, image data item F). In the pixels of each of the image data items E and F, m pixels that are consecutively aligned on the same line of each data item are transferred to the SIMD microprocessor and are subjected to an arithmetic operation by the SIMD microprocessor. Accordingly, a pixel group including the pixels in the image data item E (Pixel Group E including m pixels) and another pixel group including the pixels in the image data item F (Pixel Group F including m pixels) are transferred to the SIMD microprocessor. In a case where the pixels of Pixel Group E are successively denoted as 1, 2, 3 . . . from the left to right direction and the pixels of Pixel Group F are successively denoted as 1, 2, 3 . . . from the left to right direction, pixel 1 to pixel m in each of the Pixel Groups E and F are transferred to the SIMD microprocessor as pixels which are to be processed in a single image process. In the left part of FIG. 9, the pixels of Pixel Group F are illustrated with black triangles to be distinguished from the pixels of Pixel Group E.

In the SIMD microprocessor shown in FIG. 9, the pixels (pixel data) of Pixel Group E are arranged on the lower side of respective PEs and the pixels (pixel data) of Pixel Group F are arranged on the upper side of respective PEs. With respect to the pixels in each pixel group, pixel 1 is arranged in the first PE; then, pixel 2 is arranged in the second PE; then, pixel 3 is arranged in the third PE; then, . . . ; and then, pixel m is arranged in the m^{th} PE. In a subsequent image process operation, the succeeding groups of target image process pixels beginning from pixel (m+1) in each group are transferred to the SIMD microprocessor.

### Second Embodiment

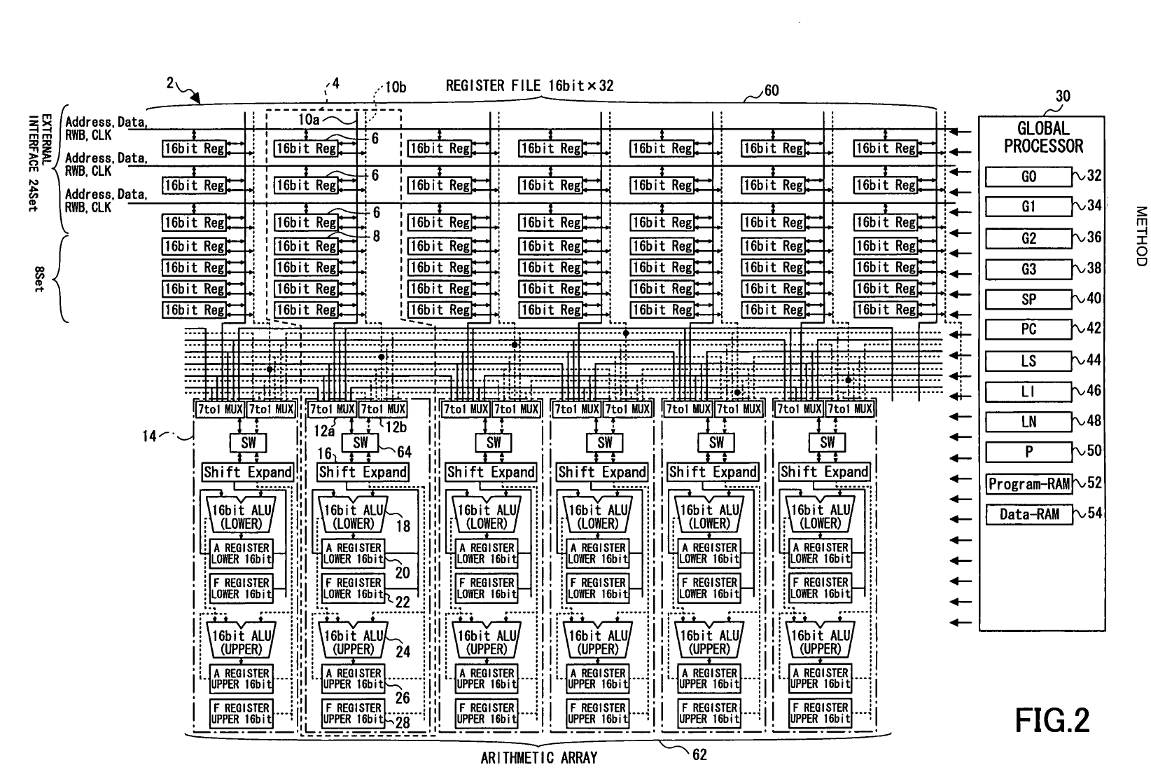

FIG. 2 is a schematic drawing showing an exemplary configuration of a SIMD microprocessor 2 according to the second embodiment of the present invention. FIG. 2 is a configuration for achieving the data with respect to the above-described first alignment pattern of pixels in an SIMD microprocessor (as shown in FIG. 5), in which an arithmetic unit of one PE uses data stored in a register of a neighboring PE. It is to be noted that the SIMD microprocessor 2 according to the second embodiment of the present invention has a configuration which is substantially the same as that of the SIMD microprocessor 2 according to the first embodiment of the present invention. Therefore, like components are denoted with like numerals as of the first embodiment and are not further described. Accordingly, the following mainly describes the differences between the first and second embodiments of the present invention.

The same as FIG. 1, FIG. 2 mainly shows six PEs 4 provided at the center portion of the processor element group 72 (See FIG. 16).

In the register file 60, each PE includes plural 16 bit registers (6, 8) which are arranged in groups corresponding to the number of PEs, to thereby form an array configuration. Each register (6, 8) is provided with a port for the arithmetic array 62. The arithmetic array 62 accesses the registers (6, 8) via a pair of 8 bit read/write register buses (lower register bus 10a, upper register bus 10b). In the pair of the 8 bit register buses (10a, 10b), the lower register bus 10a corresponds to the lower 8 bits of the 16 bit registers (6, 8) and the upper register bus 10b corresponds to the upper 8 bits of the 16 bit registers (6, 8). In FIG. 2, the lower register bus 10a is illustrated with solid lines, and the upper register bus 10b is illustrated with broken lines. For the sake of convenience, FIG. 2 shows each PE 4 having seven registers (6, 8).

Furthermore, the data path inside the arithmetic array 62 is illustrated with solid lines for those related to the arithmetic operation for lower bit data and broken lines for those related to the arithmetic operation for upper bit data.

Two 7 to 1 multiplexers (upper multiplexer 12a, lower multiplexer 12b) are provided at the connection part between the 16 bit registers (6, 8) and the arithmetic part 14. The two 7 to 1 multiplexers (12a, 12b) are selection circuits in which each has a bit width of 8 bits. The lower multiplexer 12a is connected to plural lower register buses 10a and the upper multiplexer 12b is connected to plural upper register buses 10b.

The lower multiplexer 12a is connected to the lower register bus 10a corresponding to its own PE (primary PE) 4 and the lower register buses 10a corresponding to adjacent PEs that are aligned in the horizontal direction of FIG. 1. The upper multiplexer 12b is connected to the upper register bus 10b corresponding to its own PE (primary PE) 4 and the upper register buses 10b corresponding to adjacent PEs that are aligned in the horizontal direction of FIG. 1. In this example, the lower multiplexer 12a is connected to the lower register bus 10a corresponding to its own PE (primary PE) 4, the lower register buses 10a corresponding to the three PEs 4 (the first left PE 4, the second left PE 4, and the third left PE 4) aligned on its left side, and the lower register buses 10a for the three PEs 4 (the first right PE, the second right PE 4, and the third right PE4) aligned on its right side. In this example, the upper multiplexer 12b is connected to the upper register bus 10b corresponding to its own PE (primary PE) 4, the upper register buses 10b corresponding to the three PEs 4 (the first left PE 4, the second left PE 4, and the third left PE 4) aligned on its left side, and the upper register buses 10b for the three PEs 4 (the first right PE, the second right PE 4, and the third right PE4) aligned on its right side. Accordingly, the data in the registers (6, 8) corresponding to the upper and lower register buses 10a, 10b are selected as the target on which the arithmetic operation is performed. The global processor 30 controls the selection of the arithmetic operation target.

A switch 64 is provided between the upper/lower 7 to 1 multiplexers (12a, 12b) and the ALU (18, 24). The switch 64 has a function of switching the paths for upper bit data and lower bit data. With this switching function, a basic state of having the lower multiplexer 12a connected to the lower ALU 18 and having the upper multiplexer 12b connected to the upper ALU 24 is switched to a cross-over state of having the lower multiplexer 12a connected to the upper ALU 24 and having the upper multiplexer 12b connected to the lower ALU 18 (and also switching back from the cross-over state to the basic state). The global processor 30 controls the switch 60, that is, controls the switching between the basic state and the cross-over state.

A shifter (Shift Expand) 16 is provided between the switch 64 and the ALU (18, 24). The shifter 16 performs bit shift and bit expansion on the data read out from the 16 bit registers (6, 8). The global processor 30 controls the bit shift and bit expansion of the shifter 16.

The three upper registers 6 included in the register file 60 are registers to which reading/writing of data from an external memory data transfer apparatus (not shown) outside of the microprocessor 2 is performed.

Next, the operation of the SIMD microprocessor according to the second embodiment of the present invention (shown in FIG. 2) is described.

In the SIMD microprocessor 2 shown in FIG. 2, image data are transferred from outside via the external interface 70. The following examples describe a case where image data (pixel data) are already transferred from an external memory data transfer apparatus (not shown) to the registers 6 of each PE 4.

The first example describes a case where the data size of a pixel (pixel data size) is 16 bits. However, this case is different from the case of using the first alignment pattern of pixels (as shown in FIG. 5) in that a single PE processes a single pixel.

Since the size of the 16 bit registers (6, 8) and the width of the path (upper and lower data path combined) from the 16 bit registers (6, 8) to the ALU (18, 24) are 16 bits, 16 bit data can be satisfactorily transferred.

The shifter 16, positioned in between the registers (6, 8) and the ALU (18, 24), expands the transferred data to 32 bit length. The upper 16 bits of the expanded 32 bit data are guided to the upper bit ALU 24 and the lower 16 bits of the expanded 32 bit data are guided to the lower bit ALU 18. The guided data are referred to as “X data”. In this case, the global processor 30 performs control so that the lower 7 to 1 multiplexer 12a and upper 7 to 1 multiplexer 12b execute the same operation and the switch 64 does not execute the switching function.

The A registers (20, 26), which not only store arithmetic results therein but also serve as a source for supplying data to the ALU (18, 24), together supply 32 bit data to the ALU (18, 24). The supplied data are referred to as “Y data”. The ALU (18, 24), receiving the X data and the Y data, performs an arithmetic operation on the received data. In this arithmetic operation, the upper bit ALU 24 and the lower bit ALU 18 operate together as a single 32 bit arithmetic unit. Typically, in a case where two arithmetic units (each having a predetermined bit size) are used to perform an arithmetic operation on data that is twice the size of the predetermined bit size, signals are to be transmitted between the two arithmetic units. In this example, an information transmission path provided between the upper bit ALU 24 and the lower bit ALU 18 is used.

In the arithmetic operation performed on the X data and the Y data, the data subjected to the arithmetic operation are both 32 bit data. Accordingly, the arithmetic result also becomes 32 bit data. The upper 16 bits of the arithmetic results are stored in the upper bit A register 26, and the lower 16 bits of the arithmetic results are stored in the lower bit A register 20. Thus, the A registers (26, 20) again become the sources for supplying data to the ALU (18, 24).

As described above, during the process of performing the arithmetic operation, the data subjected to the arithmetic operation becomes 32 bits. Therefore, in returning the resultant 32 bit data to the register file 60, the 32 bit data are formatted to 16 bit data and returned to the register file 60 as 16 bit data. In this example, the formatting is performed by bit shifting the 32 bit data and using only the lower 16 bits.

In a case of executing an image process, such as a filter process, there is sometimes a need to obtain data of a neighboring pixel. The SIMD microprocessor 2 shown in FIG. 2 has the 7 to 1 multiplexers (12a, 12b) provided at the connecting part between the registers (6, 8) and the arithmetic part 14 and is configured to select the first left PE 4, the second left PE 4, and the third left PE 4 or the first right PE 4, the second right PE 4, and the third right PE 4 (three adjacent PEs in the horizontal direction as shown in FIG. 2). By matching the alignment of the pixels and the alignment of the PEs beforehand, a neighboring (adjacent) PE will contain data of a neighboring (adjacent) pixel. Thereby, the arithmetic operation results of the arithmetic part 14 of each PE can be used for the data of an adjacent pixel.

The second example describes a case where the data size of a pixel (pixel data size) is 8 bits. However, this case uses the first alignment pattern of pixels (as shown in FIG. 5), that is, two pixels are processed with a single PE.

In a case where the data size of a pixel is 8 bits, each PE 4 in the SIMD microprocessor 2 shown in FIG. 2 performs image processing on two pixels. First, two 8 bit data items are stored in the registers (6, 8). That is, in the 16 bit data size (16 bit data space) of each register (6, 8), data items of two pixels are separately stored in the upper 8 bit space and the lower bit space of the registers (6, 8). In transferring data from the registers (6, 8) to the arithmetic part 14, the upper 8 bit data are transferred through the upper register bus 10b, and the lower 8 bit data are transferred through the lower register bus 10a.

The data of the registers (6, 8) are guided to the arithmetic array 62 via the upper or lower multiplexer 12a, 12b and the switch 64.

In the shifter 16 positioned in between the registers (6, 8) and the switch 64, each of the upper 8 bit data and the lower 8 bit data are expanded into 16 bit data. Thereby, the upper 16 bits are guided to the upper bit ALU 24 and the lower 16 bits are guided to the lower bit ALU 18. The upper 16 bit data item is referred to as “XH data”, and the lower 16 bit data item is referred to as “XL data”.

The A registers (20, 26), which not only store arithmetic results therein but also serve as a source for supplying data to the ALU (18, 24), supplies upper and lower 16 bit data to the ALU 18 and the ALU 24, respectively. The supplied upper data are referred to as “YH data”, and the supplied lower data are referred to as “YL data”. The lower ALU 18, receiving the XL data and the YL data, performs an arithmetic operation on the received data. The upper ALU 24, receiving the XH data and the YH data, performs an arithmetic operation on the received data. In this arithmetic operation, the upper bit ALU 24 and the lower bit ALU 18 each operates as an independent 16 bit arithmetic unit. In this case, an information transmission path provided between the upper bit ALU 24 and the lower bit ALU 18 is not used.

In the arithmetic operation performed on the XL data and the YL data and the arithmetic operation performed on the XH data and the YH data, the data subjected to the arithmetic operations are 16 bit data. Accordingly, the arithmetic result also becomes 16 bit data. The 16 bit data of the arithmetic result from the upper ALU 24 are stored in the upper bit A register 26, and the 16 bit data of the arithmetic result from the lower ALU are stored in the lower bit A register 20. Thus, the A registers (26, 20) again become the sources for supplying data to the ALU (18, 24).

As described above, during the process of performing the arithmetic operations, the data subjected to the arithmetic operation become 16 bits. Therefore, in returning the resultant 16 bit data to the register file 60, the 16 bit data are formatted to two 8 bit data items and returned to the register file 60 as two 8 bit data items. In this example, the formatting is performed by bit shifting the 16 bit data, using only the lower 8 bits, and combining the upper 8 bit data and the lower 8 bit data at the shifter 16, to thereby form a single 16 bit data item.

Next, the steps for referring to a neighboring or adjacent pixel with the SIMD microprocessor using the first alignment pattern according to the second embodiment of the present invention is described.

First, the following describes a case of performing an arithmetic operation on lower bit pixel data in a lower ALU 18 of each PE 4.

For example, with reference to FIG. 5, in a case of referring to the first pixel (pixel data) on the right of a predetermined pixel in an image data item, the target reference pixel is stored in an upper 8 bit space of a register in the same PE (base PE) 4. In this case, data can be referred to by selecting the register bus 10b corresponding to the base PE 4 with the upper MUX 12b of the base PE4 and performing switching of upper and lower bits with the switch 64.

In a case of referring to the second pixel (pixel data) on the right of a predetermined pixel in an image data item, the target reference pixel is stored in a lower 8 bit space of a register in the first right PE 4. In this case, data can be referred to by selecting the first right register bus 10a with the lower MUX 12a of the base PE4 and not performing switching of upper and lower bits with the switch 64.

In a case of referring to the third pixel (pixel data) on the right of a predetermined pixel in an image data item, the target reference pixel is stored in an upper 8 bit space of a register in the first right PE 4. In this case, data can be referred to by selecting the first right register bus 10b with the upper MUX 12b of the base PE4 and performing switching of upper and lower bits with the switch 64.

In a case of referring to the first pixel (pixel data) on the left of a predetermined pixel in an image data item, the target reference pixel is stored in an upper 8 bit space of a register in the first left PE 4. In this case, data can be referred to by selecting the first left register bus 10b with the upper MUX 12b of the base PE4 and performing switching of upper and lower bits with the switch 64.

In a case of referring to the second pixel (pixel data) on the left of a predetermined pixel in an image data item, the target reference pixel is stored in a lower 8 bit space of a register in the first left PE 4. In this case, data can be referred to by selecting the first left register bus 10a with the lower MUX 12a of the base PE4 and not performing switching of upper and lower bits with the switch 64.

In a case of referring to the third pixel (pixel data) on the left of a predetermined pixel in an image data item, the target reference pixel is stored in an upper 8 bit space of a register in the second left PE 4. In this case, data can be referred to by selecting the second left register bus 10b with the upper MUX 12b of the base PE4 and performing switching of upper and lower bits with the switch 64.

Next, the following describes a case of performing an arithmetic operation on upper bit pixel data in an upper ALU 18 of each PE 4.

In this example, with reference to FIG. 5, in a case of referring to the first pixel (pixel data) on the right of a predetermined pixel in an image data item, the target reference pixel is stored in a lower 8 bit space of a register in the first right PE 4. In this case, data can be referred to by selecting the first right register bus 10a with the lower MUX 12a of the base PE4 and performing switching of upper and lower bits with the switch 64.

In a case of referring to the second pixel (pixel data) on the right of a predetermined pixel in an image data item, the target reference pixel is stored in an upper 8 bit space of a register in the first right PE 4. In this case, data can be referred to by selecting the first right register bus 10b with the upper MUX 12b of the base PE4 and not performing switching of upper and lower bits with the switch 64.

In a case of referring to the third pixel (pixel data) on the right of a predetermined pixel in an image data item, the target reference pixel is stored in a lower 8 bit space of a register in the second right PE 4. In this case, data can be referred to by selecting the second right register bus 10a with the lower MUX 12a of the base PE4 and performing switching of upper and lower bits with the switch 64.

In a case of referring to the first pixel (pixel data) on the left of a predetermined pixel in an image data item, the target reference pixel is stored in a lower 8 bit space of a register in the same PE (base PE) 4. In this case, data can be referred to by selecting the register bus 10a corresponding to the base PE 4 with the lower MUX 12a of the base PE4 and performing switching of upper and lower bits with the switch 64.

In a case of referring to the second pixel (pixel data) on the left of a predetermined pixel in an image data item, the target reference pixel is stored in an upper 8 bit space of a register in the first left PE 4. In this case, data can be referred to by selecting the first left register bus 10b with the upper MUX 12b of the base PE4 and not performing switching of upper and lower bits with the switch 64.

In a case of referring to the third pixel (pixel data) on the left of a predetermined pixel in an image data item, the target reference pixel is stored in a lower 8 bit space of a register in the first left PE 4. In this case, data can be referred to by selecting the first left register bus 10a with the lower MUX 12a of the base PE4 and performing switching of upper and lower bits with the switch 64.

Accordingly, the switching of the switch 64 corresponds to the referring of data based the upper side pixels and the referring of data based on the upper side pixels. Therefore, in the data referring operation, the global processor 30 can uniformly perform control on all of the PEs 4. The lower and upper multiplexers 12a, 12b in all of the PEs 4 are uniformly controlled by the global processor 30.

### Third Embodiment

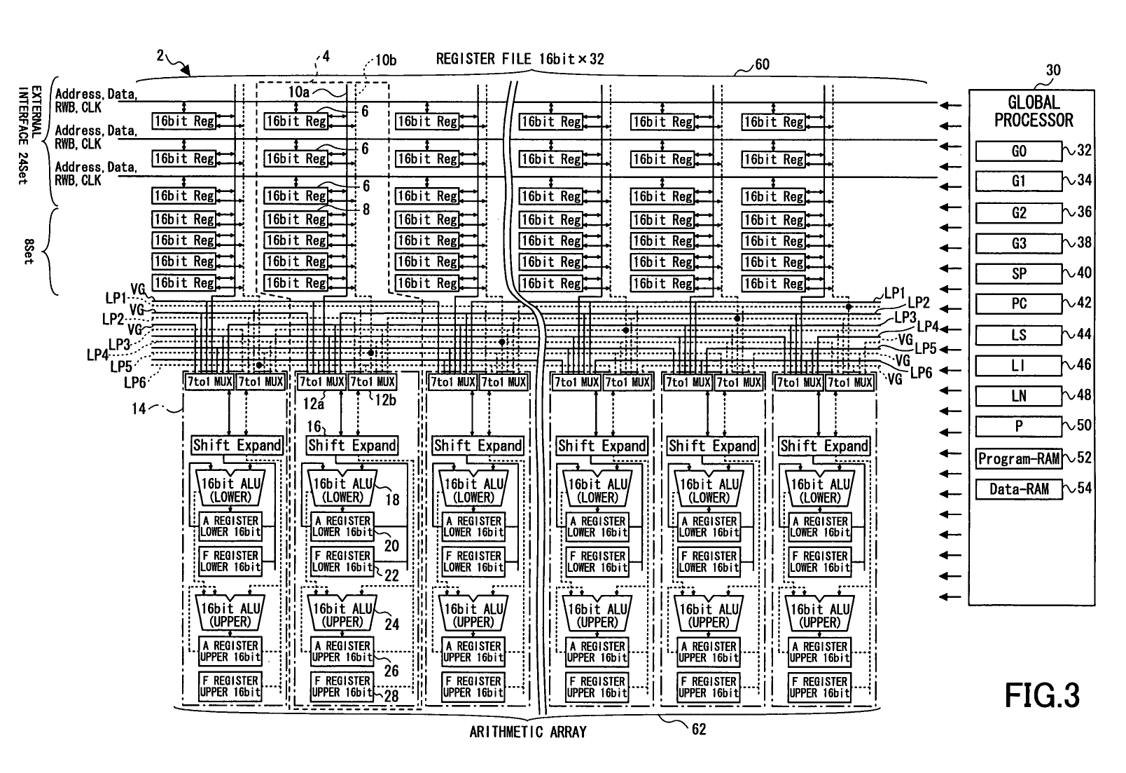

FIG. 3 is a schematic drawing showing an exemplary configuration of a SIMD microprocessor 2 according to the third embodiment of the present invention. FIG. 3 is a configuration for achieving the data with respect to the above-described second alignment pattern of pixels in an SIMD microprocessor (as shown in FIG. 6), in which an arithmetic unit of one PE uses data stored in a register of a neighboring PE. It is to be noted that the SIMD microprocessor 2 according to the third embodiment of the present invention has a configuration which is substantially the same as that of the SIMD microprocessor 2 according to the second embodiment of the present invention. Therefore, like components are denoted with like numerals as of the second embodiment and are not further described. Accordingly, the following mainly describes the differences between the first and second embodiments of the present invention.

In the register file 60, each PE includes plural 16 bit registers (6, 8) which are arranged in groups corresponding to the number of PEs, to thereby form an array configuration. Each register (6, 8) is provided with a port for the arithmetic array 62. The arithmetic array 62 accesses the registers (6, 8) via a pair of 8 bit read/write register buses (lower register bus 10a, upper register bus 10b). In the pair of the 8 bit register buses (10a, 10b), the lower register bus 10a corresponds to the lower 8 bits of the 16 bit registers (6, 8) and the upper register bus 10b corresponds to the upper 8 bits of the 16 bit registers (6, 8). In FIG. 3, the lower register bus 10a is illustrated with solid lines, and the upper register bus 10b is illustrated with broken lines. For the sake of convenience, FIG. 2 shows each PE 4 having seven registers (6, 8).

Different from FIGS. 1 and 2, FIG. 3 mainly shows three PEs that are provided on each side of the processor element group 72 shown in FIG. 16.

In this example shown in FIG. 3, supposing that the number of PEs included in the SIMD processor 2 is m, each PEs is identified as follows. With reference to FIG. 3, from the left to right direction, the PE situated on the leftmost end is identified as PE[1], the PE situated second from the leftmost end is identified as PE[2], the PE situated third from the leftmost end is identified as PE[3], . . . (further identification PEs in-between omitted for the sake of convenience), and from the right to left direction, the PE situated on the rightmost end is identified as PE[m], the PE situated second from the rightmost end is identified as PE[m−1], the PE situated third from the rightmost end is identified as PE[m−2] . . . (further identification of PEs in-between omitted for the sake of convenience).

Furthermore, the data path inside the arithmetic array 62 is illustrated with solid lines for those related to the arithmetic operation for lower bit data and broken lines for those related to the arithmetic operation for upper bit data.

Two 7 to 1 multiplexers (upper multiplexer 12a, lower multiplexer 12b) are provided at the connection part between the 16 bit registers (6, 8) and the arithmetic part 14. The two 7 to 1 multiplexers (12a, 12b) are selection circuits in which each has a bit width of 8 bits. The lower multiplexer 12a is connected to plural lower register buses 10a and the upper multiplexer 12b is connected to plural upper register buses 10b.

The lower multiplexer 12a is connected to the lower register bus 10a corresponding to its own PE (primary PE) 4 and the lower register buses 10a corresponding to adjacent PEs that are aligned in the horizontal direction of FIG. 1. The upper multiplexer 12b is connected to the upper register bus 10b corresponding to its own PE (primary PE) 4 and the upper register buses 10b corresponding to adjacent PEs that are aligned in the horizontal direction of FIG. 1. In this example, the lower multiplexer 12a is connected to the lower register bus 10a corresponding to its own PE (primary PE) 4, the lower register buses 10a corresponding to the three PEs 4 (the first left PE 4, the second left PE 4, and the third left PE 4) aligned on its left side, and the lower register buses 10a for the three PEs 4 (the first right PE, the second right PE 4, and the third right PE4) aligned on its right side. In this example, the upper multiplexer 12b is connected to the upper register bus 10b corresponding to its own PE (primary PE) 4, the upper register buses 10b corresponding to the three PEs 4 (the first left PE 4, the second left PE 4, and the third left PE 4) aligned on its left side, and the upper register buses 10b for the three PEs 4 (the first right PE, the second right PE 4, and the third right PE4) aligned on its right side.

Accordingly, the data in the registers (6, 8) corresponding to the upper and lower register buses 10a, 10b are selected as the target to which the arithmetic operation is performed. The global processor 30 controls the selection of the arithmetic operation target.

In some cases where a PE situated in the vicinity of the left end of the array of PEs 4 in a processor element group 72 attempts to refer to data in another PE situated on its left side (or where a PE situated in the vicinity of the right end of the array of PEs 4 in a processor element group 72 attempts to refer to data in another PE situated on its right side), the PE targeted for such reference may not exist. Usually in this case, a provisional reference value is set as the data to be read-out. For example, the provisional reference value may be a data item in which all of its bits are “0” or a data item in which all of its bits are “1”.

In the exemplary array of PEs 4 shown in FIG. 3, a fixed value VG is assigned as the reference value since there is no PE existing on the left side of the PE[1] in a case where the lower multiplexer 12a of PE[1] attempts to refer to data in the registers (6, 8) on its left side.

Likewise, in the exemplary array of PEs 4 shown in FIG. 3, a fixed value VG is assigned as the reference value since there is no existing PE in a case where the lower multiplexer 12a of PE[2] attempts to refer to data in the registers (6, 8) of a PE situated two or more PEs left of the PE[2], or in a case where the lower multiplexer 12a of PE[3] attempts to refer to data in the registers (6, 8) of a PE situated three or more PEs left of the PE[3].

Furthermore, in the exemplary array of PEs 4 shown in FIG. 3, there is no PE existing on the left side of the PE[1] in a case where the upper multiplexer 12b of PE[1] attempts to refer to data in the registers (6, 8) on its left side. However, the lower register bus 10a of the PE situated at the rightmost end (i.e. PE[m]) is connected as a register bus of the first PE on the left of the PE[1]. Likewise, the lower register bus 10a of the PE[m−1] is connected as a register bus of the second PE on the left of the PE[1], and the lower register bus 10a of the PE[m−2] is connected as a register bus of the third PE on the left of the PE[1].

The same as the PE[1], the upper multiplexer 12b of the PE[2] is connected to the upper register bus 10b of the PE[1] as a register bus of the first PE on the left of the PE[2]. Likewise, the lower register bus 10a of the PE[m] is connected as a register bus of the second PE on the left of the PE[2], and the lower register bus 10a of the PE[m−1] is connected as a register bus of the third PE on the left of the PE[2]. With respect to PE[3], the upper register bus 10b of the PE[2] is connected as a register bus of the first PE on the left of the PE[2], the upper register bus 10b of the PE[1] is connected as a register bus of the second PE on the left of the PE[3], and the lower register bus 10a of the PE[m] is connected as a register bus of the third PE on the left of the PE[3].

In the exemplary array of PEs 4 shown in FIG. 3, a fixed value VG is assigned as the reference value since there is no PE existing on the right side of the PE[m] in a case where the upper multiplexer 12b of PE[m] attempts to refer to data in the registers (6, 8) on its right side.

Likewise, in the exemplary array of PEs 4 shown in FIG. 3, a fixed value VG is assigned as the reference value since there is no existing PE in a case where the upper multiplexer 12b of PE[m−1] attempts to refer to data in the registers (6, 8) of a PE situated two or more PEs right of the PE[m−1], or in a case where the upper multiplexer 12b of PE[m−2] attempts to refer to data in the registers (6, 8) of a PE situated three or more PEs right of the PE[m−2].

Furthermore, in the exemplary array of PEs 4 shown in FIG. 3, there is no PE existing on the right side of the PE[m] in a case where the lower multiplexer 12a of PE[m] attempts to refer to data in the registers (6, 8) on its right side. However, the upper register bus 10b of the PE situated at the leftmost end (i.e. PE[1]) is connected as a register bus of the first PE on the right of the PE[m]. Likewise, the upper register bus 10b of the PE[2] is connected as a register bus of the second PE on the right of the PE[m], and the upper register bus 10b of the PE[3] is connected as a register bus of the third PE on the right of the PE[m].

The same as the PE[m], the lower multiplexer 12a of the PE[m−1] is connected to the lower register bus 10a of the PE[m] as a register bus of the first PE on the right of the PE[m−1]. Likewise, the upper register bus 10b of the PE[1] is connected as a register bus of the second PE on the right of the PE[m−1], and the upper register bus 10b of the PE[2] is connected as a register bus of the third PE on the right of the PE[m−1]. With respect to PE[m−2], the lower register bus 10a of the PE[m−1] is connected as a register bus of the first PE on the right of the PE[m−2], the lower register bus 10a of the PE[m] is connected as a register bus of the second PE on the right of the PE[m−2], and the upper register bus 10b of the PE[1] is connected as a register bus of the third PE on the right of the PE[m−2].

A shifter (Shift Expand) 16 is provided between the 7 to 1 multiplexers (12a, 12b) and the ALU (18, 24). The shifter 16 performs bit shift and bit expansion on the data read out from the 16 bit registers (6, 8). The global processor 30 controls the bit shift and bit expansion of the shifter 16.

The three upper registers 6 included in the register file 30 are registers to which reading/writing of data from an external memory data transfer apparatus (not shown) outside of the microprocessor 2 is performed.

Next, the operation of the SIMD microprocessor according to the third embodiment of the present invention (shown in FIG. 3) is described.

In the SIMD microprocessor 2 shown in FIG. 3, image data is transferred from outside via the external interface 70. The following examples describe a case where image data (pixel data) is already transferred from an external memory data transfer apparatus (not shown) to the registers 6 of each PE 4.

The first example describes a case where the data size of a pixel (pixel data size) is 16 bits. However, this case is different from the case of using the second alignment pattern of pixels (as shown in FIG. 6) in that a single PE processes a single pixel.

Since the size of the 16 bit registers (6, 8) and the width of the path (upper and lower data path combined) from the 16 bit registers (6, 8) to the ALU (18, 24) are 16 bits, 16 bit data can be satisfactorily transferred.

The shifter 16, positioned in between the registers (6, 8) and the ALU (18, 24), expands the transferred data to 32 bit length. The upper 16 bits of the expanded 32 bit data are guided to the upper bit ALU 24 and the lower 16 bits of the expanded 32 bit data are guided to the lower bit ALU 18. The guided data is referred to as “X data”. In this case, the global processor 30 performs control so that the lower 7 to 1 multiplexer 12a and upper 7 to 1 multiplexer 12b execute the same operation.

The A registers (20, 26), which not only store arithmetic results therein but also serve as a source for supplying data to the ALU (18, 24), together supply 32 bit data to the ALU (18, 24). The supplied data is referred to as “Y data”. The ALU (18, 24), receiving the X data and the Y data, performs an arithmetic operation on the received data. In this arithmetic operation, the upper bit ALU 24 and the lower bit ALU 18 operate together as a single 32 bit arithmetic unit. Typically, in a case where two arithmetic units (each having a predetermined bit size) are used to perform an arithmetic operation on data that is twice the size of the predetermined bit size, signals are to be transmitted between the two arithmetic units. In this example, an information transmission path provided between the upper bit ALU 24 and the lower bit ALU 18 is used.

In the arithmetic operation performed on the X data and the Y data, the data subjected to the arithmetic operation are both 32 bit data. Accordingly, the arithmetic result also becomes 32 bit data. The upper 16 bits of the arithmetic result is stored in the upper bit A register 26, and the lower 16 bits of the arithmetic result is stored in the lower bit A register 20. Thus, the A registers (26, 20) again become the sources for supplying data to the ALU (18, 24).

As described above, during the process of performing the arithmetic operation, the data subjected to the arithmetic operation becomes 32 bits. Therefore, in returning the resultant 32 bit data to the register file 60, the 32 bit data are formatted to 16 bit data and returned to the register file 60 as 16 bit data. In this example, the formatting is performed by bit shifting the 32 bit data and using only its lower 16 bits.

In a case of executing an image process, such as a filter process, there is sometimes a need to obtain data of a neighboring pixel. The SIMD microprocessor 2 shown in FIG. 3 has the 7 to 1 multiplexers (12a, 12b) provided at the connecting part between the registers (6, 8) and the arithmetic part 14 and is configured to select the first left PE 4, the second left PE 4, and the third left PE 4 or the first right PE 4, the second right PE 4, and the third right PE 4 (three adjacent PEs in the horizontal direction as shown in FIG. 2). By matching the alignment of the pixels and the alignment of the PEs beforehand, a neighboring (adjacent) PE will contain data of a neighboring (adjacent) pixel. Thereby, the arithmetic operation results of the arithmetic part 14 of each PE can be used for the data of an adjacent pixel. In this case, the global processor 30 performs control so that the lower 7 to 1 multiplexer 12a and upper 7 to 1 multiplexer 12b execute the same operation.

The second example describes a case where the data size of a pixel (pixel data size) is 8 bits. However, this case uses the second alignment pattern of pixels (as shown in FIG. 6), that is, two pixels are processed with a single PE.

In a case where the data size of a pixel is 8 bits, each PE 4 in the SIMD microprocessor 2 shown in FIG. 3 performs image processing on two pixels. First, two 8 bit data items are stored in the registers (6, 8). That is, in the 16 bit data size (16 bit data space) of each register (6, 8), data items of two pixels are separately stored in the upper 8 bit space and the lower bit space of the registers (6, 8). In transferring data from the registers (6, 8) to the arithmetic part 14, the upper 8 bit data are transferred through the upper register bus 10b, and the lower 8 bit data are transferred through the lower register bus 10a.

The data of the registers (6, 8) are guided to the arithmetic array 62 via the upper or lower multiplexer 12a, 12b and the switch 64.

In the shifter 16 positioned in between the registers (6, 8) and the switch 64, each of the upper 8 bit data and the lower 8 bit data are expanded into 16 bit data. Thereby, the upper 16 bits are guided to the upper bit ALU 24 and the lower 16 bits are guided to the lower bit ALU 18. The upper 16 bit data item is referred to as “XH data”, and the lower 16 bit data item is referred to as “XL data”.

The A registers (20, 26), which not only store arithmetic results therein but also serve as a source for supplying data to the ALU (18, 24), supplies upper and lower 16 bit data to the ALU 18 and the ALU 24, respectively. The supplied upper data is referred to as “YH data”, and the supplied lower data is referred to as “YL data”. The lower ALU 18, receiving the XL data and the YL data, performs an arithmetic operation on the received data. The upper ALU 24, receiving the XH data and the YH data, performs an arithmetic operation on the received data. In this arithmetic operation, the upper bit ALU 24 and the lower bit ALU 18 each operates as an independent 16 bit arithmetic unit. In this case, an information transmission path provided between the upper bit ALU 24 and the lower bit ALU 18 is not used.

In the arithmetic operation performed on the XL data and the YL data and the arithmetic operation performed on the XH data and the YH data, the data subjected to the arithmetic operations are 16 bit data. Accordingly, the arithmetic result also becomes 16 bit data. The 16 bit data of the arithmetic result from the upper ALU 24 is stored in the upper bit A register 26, and the 16 bit data of the arithmetic result from the lower ALU is stored in the lower bit A register 20. Thus, the A registers (26, 20) again become the sources for supplying data to the ALU (18, 24).

As described above, during the process of performing the arithmetic operations, the data subjected to the arithmetic operation becomes 16 bits. Therefore, in returning the resultant 16 bit data to the register file 60, the 16 bit data are formatted to two 8 bit data items and returned to the register file 60 as two 8 bit data items. In this example, the formatting is performed by bit shifting the 16 bit data, using only the lower 8 bits, and combining the upper 8 bit data and the lower 8 bit data at the shifter 16, to thereby form a single 16 bit data item.

Next, the steps for referring to a neighboring or adjacent pixel with the SIMD microprocessor using the second alignment pattern according to the third embodiment of the present invention is described.

Same as a case of performing an arithmetic operation on a single pixel with a singe PE, the path between the arithmetic part 14 and the registers (6, 8) for referring to one-three neighboring or adjacent pixels are determined by the PEs situated on both ends of the alignment of PEs. That is, in the following describes an example of continuously determining the order (process) of referring to neighboring or adjacent pixels in two pixel groups (from pixel 1 to pixel m, from pixel (m+1) to pixel (2×m)) by employing the secondary alignment pattern of pixels shown in FIG. 6.

First, pixel (m+1), pixel (m+2), and pixel (m+3) can be referred to for performing an arithmetic operation on pixel (m). That is, although pixel m is processed on the lower side of the ALU 18 of PE[m], the lower multiplexer 12a of PE[m] connects to the upper register bus 12b of PE[1] for referring to one pixel on the right of pixel (m), to the upper register bus 12b of PE[2] for referring to two pixels on the right of pixel (m), and to the upper register bus 12b of PE[3] for referring to three pixels on the right of pixel (m). Thereby, pixel (m+1), pixel (m+2), and pixel (m+3) can be referred to.

Next, pixel (m+1) and pixel (m+2) can be referred to for performing an arithmetic operation on pixel (m−1). That is, although pixel (m−1) is processed on the lower side of the ALU 18 of PE[m−1], the lower multiplexer 12a of PE[m−1] connects to the upper register bus 12b of PE[1] for referring to two pixel on the right of pixel (m−1) and to the upper register bus 12b of PE[2] for referring to three pixels on the right of pixel (m−1). Thereby, pixel (m+1) and pixel (m+2) can be referred to.

Next, pixel (m+1) can be referred to for performing an arithmetic operation on pixel (m−2). That is, although pixel (m−2) is processed on the lower side of the ALU 18 of PE[m−2], the lower multiplexer 12a of PE[m−2] connects to the upper register bus 12b of PE[1] for referring to three pixel on the right of pixel (m−2). Thereby, pixel (m+1) can be referred to.

Next, pixel (m), pixel (m−1), and pixel (m−2) can be referred to for performing an arithmetic operation on pixel (m+1). That is, although pixel (m+1) is processed on the lower side of the ALU 24 of PE[1], the upper multiplexer 12b of PE[1] connects to the lower register bus 12a of PE[m] for referring to one pixel on the left of pixel (m+1), to the lower register bus 12a of PE[m−1] for referring to two pixels on the left of pixel (m+1), and to the lower register bus 12a of PE[m−2] for referring to three pixels on the left of pixel (m+1). Thereby, pixel (m), pixel (m−1), and pixel (m−2) can be referred to.

Next, pixel (m) and pixel (m−1) can be referred to for performing an arithmetic operation on pixel (m+2). That is, although pixel (m+2) is processed on the upper side of the ALU 24 of PE[2], the upper multiplexer 12b of PE[2] connects to the lower register bus 12a of PE[m] for referring to two pixels on the left of pixel (m+2) and to the lower register bus 12a of PE[m−1] for referring to three pixels on the left of pixel (m+2). Thereby, pixel (m) and pixel (m−1) can be referred to.

Next, pixel (m) can be referred to for performing an arithmetic operation on pixel (m+2). That is, although pixel (m+2) is processed on the upper side of the ALU 24 of PE[2], the upper multiplexer 12b of PE[2] connects to the lower register bus 12a of PE[m] for referring to three pixel on the left of pixel (m). Thereby, pixel (m) can be referred to.

### Fourth Embodiment

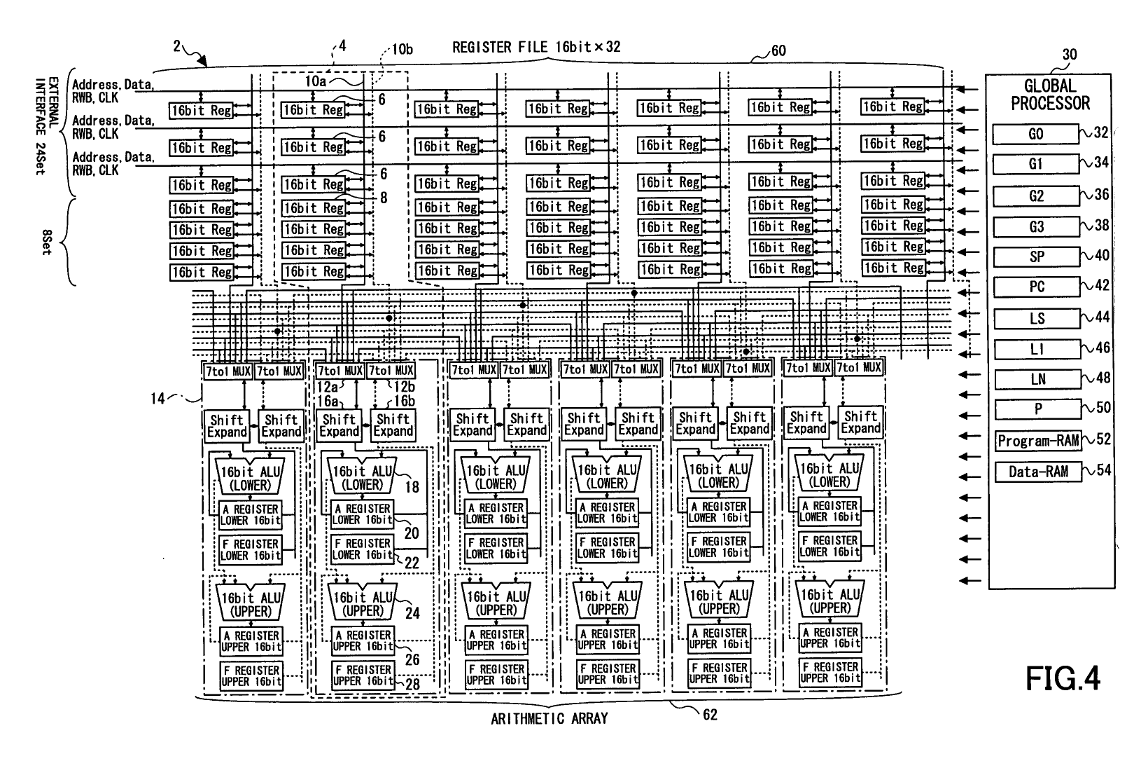

FIG. 4 is a schematic drawing showing an exemplary configuration of a SIMD microprocessor 2 according to the fourth embodiment of the present invention. FIG. 4 is a configuration for achieving the data with respect to the above-described third alignment pattern of pixels in an SIMD microprocessor (as shown in FIG. 7), the fourth alignment pattern of pixels in an SIMD microprocessor (as shown in FIG. 8), and the fifth alignment pattern of pixels in an SIMD microprocessor (as shown in FIG. 9), in which an arithmetic unit of one PE uses data stored in a register of a neighboring PE. It is to be noted that the SIMD microprocessor 2 according to the second embodiment of the present invention has a configuration which is substantially the same as that of the SIMD microprocessor 2 according to the first embodiment of the present invention. Therefore, like components are denoted with like numerals as of the first embodiment and are not further described. Accordingly, the following mainly describes the differences between the first and second embodiments of the present invention.

In the register file 60, each PE includes plural 16 bit registers (6, 8) which are arranged in groups corresponding to the number of PEs, to thereby form an array configuration. Each register (6, 8) is provided with a port for the arithmetic array 62. The arithmetic array 62 accesses the registers (6, 8) via a pair of 8 bit read/write register buses (lower register bus 10a, upper register bus 10b). In the pair of the 8 bit register buses (10a, 10b), the lower register bus 10a corresponds to the lower 8 bits of the 16 bit registers (6, 8) and the upper register bus 10b corresponds to the upper 8 bits of the 16 bit registers (6, 8). In FIG. 4, the lower register bus 10a is illustrated with solid lines, and the upper register bus 10b is illustrated with broken lines. For the sake of convenience, FIG. 2 shows each PE 4 having seven registers (6, 8).

Furthermore, the data path inside the arithmetic array 62 is illustrated with solid lines for those related to the arithmetic operation for lower bit data and broken lines for those related to the arithmetic operation for upper bit data.

Two 7 to 1 multiplexers (upper multiplexer 12a, lower multiplexer 12b) are provided at the connection part between the 16 bit registers (6, 8) and the arithmetic part 14. The two 7 to 1 multiplexers (12a, 12b) are selection circuits in which each has a bit width of 8 bits. The lower multiplexer 12a is connected to plural lower register buses 10a and the upper multiplexer 12b is connected to plural upper register buses 10b.

The lower multiplexer 12a is connected to the lower register bus 10a corresponding to its own PE (primary PE) 4 and the lower register buses 10a corresponding to adjacent PEs that are aligned in the horizontal direction of FIG. 1. The upper multiplexer 12b is connected to the upper register bus 10b corresponding to its own PE (primary PE) 4 and the upper register buses 10b corresponding to adjacent PEs that are aligned in the horizontal direction of FIG. 1. In this example, the lower multiplexer 12a is connected to the lower register bus 10a corresponding to its own PE (primary PE) 4, the lower register buses 10a corresponding to the three PEs 4 (the first left PE 4, the second left PE 4, and the third left PE 4) aligned on its left side, and the lower register buses 10a for the three PEs 4 (the first right PE, the second right PE 4, and the third right PE4) aligned on its right side. In this example, the upper multiplexer 12b is connected to the upper register bus 10b corresponding to its own PE (primary PE) 4, the upper register buses 10b corresponding to the three PEs 4 (the first left PE 4, the second left PE 4, and the third left PE 4) aligned on its left side, and the upper register buses 10b for the three PEs 4 (the first right PE, the second right PE 4, and the third right PE4) aligned on its right side. Accordingly, the data in the registers (6, 8) corresponding to the upper and lower register buses 10a, 10b are selected as the target to which the arithmetic operation is performed. The global processor 30 controls the selection of the arithmetic operation target.

Two shifters (Shift Expand) (lower shifter 16a, upper shifter 16b) are provided between the multiplexers (12a, 12b) and the ALU (18, 24). The lower shifter 16a and the upper shifter 16b each performs bit shift and bit expansion on the data read out from the 16 bit registers (6, 8). The global processor 30 controls the bit shift and bit expansion of the upper and lower shifters 16a and 16b. The lower shifter 16a and the upper shifter 16b are also configured to exchange signals with each other and function as a single shifter for performing bit shift and bit expansion on the data read out from the 16 bit registers (6, 8).

The three upper registers 6 included in the register file 60 are registers to which reading/writing of data from an external memory data transfer apparatus (not shown) outside of the microprocessor 2 is performed.

Next, the operation of the SIMD microprocessor according to the fourth embodiment of the present invention (shown in FIG. 4) is described.

In the SIMD microprocessor 2 shown in FIG. 4, image data is transferred from outside via the external interface 70. The following examples describe a case where image data (pixel data) is already transferred from an external memory data transfer apparatus (not shown) to the registers 6 of each PE 4.

The first example describes a case where the data size of a pixel (pixel data size) is 16 bits. However, this case is different from the case of using the alignment patterns of pixels (as shown in FIGS. 7, 8, and 9) in that a single PE processes a single pixel.

Since the size of the 16 bit registers (6, 8) and the width of the path (upper and lower data path combined) from the 16 bit registers (6, 8) to the ALU (18, 24) are 16 bits, 16 bit data can be satisfactorily transferred.

The upper and lower shifters 16b and 16a, positioned in between the registers (6, 8) and the ALU (18, 24), expands the transferred data to 32 bit length. The upper 16 bits of the expanded 32 bit data are guided to the upper bit ALU 24 and the lower 16 bits of the expanded 32 bit data are guided to the lower bit ALU 18. The guided data is referred to as “X data”. In this case, the global processor 30 performs control so that the lower 7 to 1 multiplexer 12a and upper 7 to 1 multiplexer 12b execute the same operation.

The A registers (20, 26), which not only store arithmetic results therein but also serve as a source for supplying data to the ALU (18, 24), together supply 32 bit data to the ALU (18, 24). The supplied data is referred to as “Y data”. The ALU (18, 24), receiving the X data and the Y data, performs an arithmetic operation on the received data. In this arithmetic operation, the upper bit ALU 24 and the lower bit ALU 18 operate together as a single 32 bit arithmetic unit. Typically, in a case where two arithmetic units (each having a predetermined bit size) are used to perform an arithmetic operation on data that is twice the size of the predetermined bit size, signals are to be transmitted between the two arithmetic units. In this example, an information transmission path provided between the upper bit ALU 24 and the lower bit ALU 18 is used.

In the arithmetic operation performed on the X data and the Y data, the data subjected to the arithmetic operation are both 32 bit data. Accordingly, the arithmetic result also becomes 32 bit data. The upper 16 bits of the arithmetic result is stored in the upper bit A register 26, and the lower 16 bits of the arithmetic result is stored in the lower bit A register 20. Thus, the A registers (26, 20) again become the sources for supplying data to the ALU (18, 24).

As described above, during the process of performing the arithmetic operation, the data subjected to the arithmetic operation becomes 32 bits. Therefore, in returning the resultant 32 bit data to the register file 60, the 32 bit data are formatted to 16 bit data and returned to the register file 60 as 16 bit data. In this example, the formatting is performed by bit shifting the 32 bit data and using only its lower 16 bits.

In a case of executing an image process, such as a filter process, there is sometimes a need to obtain data of a neighboring pixel. The SIMD microprocessor 2 shown in FIG. 4 has the 7 to 1 multiplexers (12a, 12b) provided at the connecting part between the registers (6, 8) and the arithmetic part 14 and is configured to select the first left PE 4, the second left PE 4, and the third left PE 4 or the first right PE 4, the second right PE 4, and the third right PE 4 (three adjacent PEs in the horizontal direction as shown in FIG. 4). By matching the alignment of the pixels and the alignment of the PEs beforehand, a neighboring (adjacent) PE will contain data of a neighboring (adjacent) pixel. Thereby, the arithmetic operation results of the arithmetic part 14 of each PE can be used for the data of an adjacent pixel. In this case, the global processor 30 performs control so that the lower 7 to 1 multiplexer 12a and upper 7 to 1 multiplexer 12b execute the same operation.

The second example describes a case where the data size of a pixel (pixel data size) is 8 bits. However, this case uses the above-described third, fourth, and alignment patterns of pixels (as shown in FIGS. 7, 8, and 9), that is, two pixels are processed with a single PE.

In a case where the data size of a pixel is 8 bits, each PE 4 in the SIMD microprocessor 2 shown in FIG. 4 performs image processing on two pixels. First, two 8 bit data items are stored in the registers (6, 8). That is, in the 16 bit data size (16 bit data space) of each register (6, 8), data items of two pixels are separately stored in the upper 8 bit space and the lower bit space of the registers (6, 8). In transferring data from the registers (6, 8) to the arithmetic part 14, the upper 8 bit data are transferred through the upper register bus 10b, and the lower 8 bit data are transferred through the lower register bus 10a.

The data of the registers (6, 8) are guided to the arithmetic array 62 via the upper or lower multiplexer 12a, 12b and the switch 64.

In the shifter 16 positioned in between the registers (6, 8) and the switch 64, each of the upper 8 bit data and the lower 8 bit data are expanded into 16 bit data. Thereby, the upper 16 bits are guided to the upper bit ALU 24 and the lower 16 bits are guided to the lower bit ALU 18. The upper 16 bit data item is referred to as “XH data”, and the lower 16 bit data item is referred to as “XL data”.

The operation of the lower shifter 16a for generating XL data from the data from the lower register bus 10a and the operation of the upper shifter 16b for generating XH data from the data from the upper register bus 10b are each separately controlled by the global processor 30. The global processor 30 controls the operations of the lower and upper shifters 16a, 16b so that, for example, the XL data are generated by multiplying the data from the lower register bus 10a two times (×2) by bit shifting one bit of the data from the lower register bus 10a, and the XH data are generated by multiplying the data from the upper register bus 10b four times (×4) by bit shifting two bits of the data from the upper register bus 10b.

The A registers (20, 26), which not only store arithmetic results therein but also serve as a source for supplying data to the ALU (18, 24), supplies upper and lower 16 bit data to the ALU 18 and the ALU 24, respectively. The supplied upper data is referred to as “YH data”, and the supplied lower data is referred to as “YL data”. The lower ALU 18, receiving the XL data and the YL data, performs an arithmetic operation on the received data. The upper ALU 24, receiving the XH data and the YH data, performs an arithmetic operation on the received data. In this arithmetic operation, the upper bit ALU 24 and the lower bit ALU 18 each operates as an independent 16 bit arithmetic unit. In this case, an information transmission path provided between the upper bit ALU 24 and the lower bit ALU 18 is not used.

In the arithmetic operation performed on the XL data and the YL data and the arithmetic operation performed on the XH data and the YH data, the data subjected to the arithmetic operations are 16 bit data. Accordingly, the arithmetic result also becomes 16 bit data. The 16 bit data of the arithmetic result from the upper ALU 24 is stored in the upper bit A register 26, and the 16 bit data of the arithmetic result from the lower ALU is stored in the lower bit A register 20. Thus, the A registers (26, 20) again become the sources for supplying data to the ALU (18, 24).

As described above, during the process of performing the arithmetic operations, the data subjected to the arithmetic operation becomes 16 bits. Therefore, in returning the resultant 16 bit data to the register file 60, the 16 bit data are formatted to two 8 bit data items and returned to the register file 60 as two 8 bit data items. In this example, the formatting is performed by bit shifting the 16 bit data, using only the lower 8 bits, and combining the upper 8 bit data and the lower 8 bit data at the two shifters 16a and 16b, to thereby form a single 16 bit data item.

### Other Embodiments

Although the above-described embodiments of the present invention describe a SIMD microprocessor configured to enable a single PE to process two pixels, a microprocessor enabling a single PE to process three or more pixels can also be obtained by using the present invention.

### Advantages of Second to Fourth Embodiments of Present Invention

In the SIMD microprocessor, by using the above-described alignment patterns of pixels (as shown in FIGS. 5-9), two pixels can be processed with a single PE. Accordingly, throughput (processing performance) can be doubled.

Furthermore, in a case of using the first alignment pattern (FIG. 5) for processing two pixels with a single PE in the SIMD microprocessor according to the second embodiment of the present invention (FIG. 2) or in a case of using the second alignment pattern (FIG. 6) for processing two pixels with a single PE in the SIMD microprocessor according to the third embodiment of the present invention (FIG. 3), the following advantages can be attained.

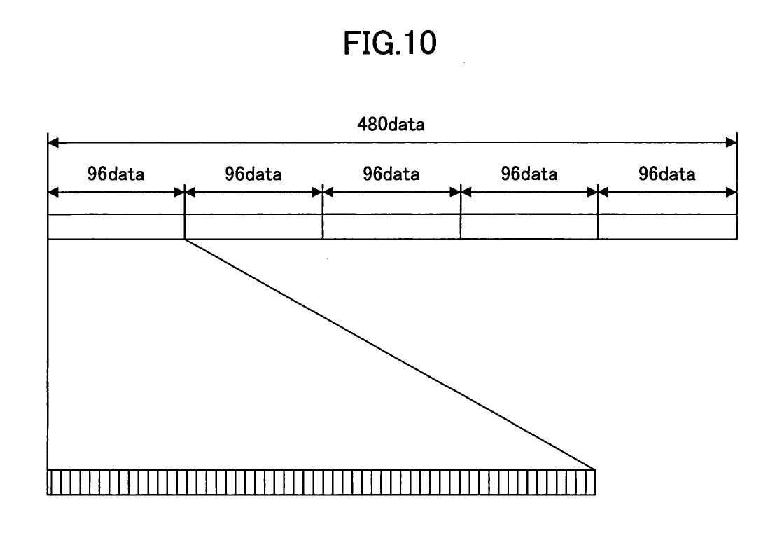

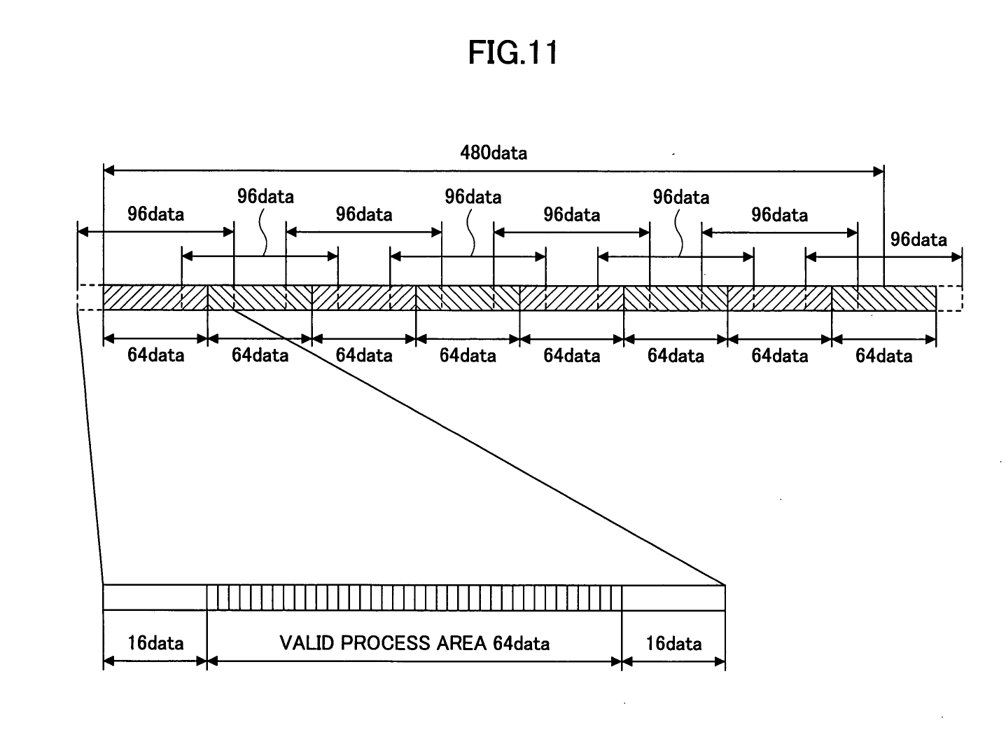

For a PE that is situated in the vicinity of either end of a PE array, an arithmetic operation may be performed based on incorrect data when data reference is made in a direction where there are no neighboring or adjacent data. Accordingly, the pixel data items situated several data items away from either end of the PE array become incorrect. As a result, these several pixel data items are abandoned as invalid pixels. This is described more specifically using the examples shown in FIGS. 10 and 11. In one example shown in FIG. 10, the number of pixels (pixel data) in the horizontal direction of an image data item is 480 pixels, and the number of pixels (pixel data) that can be processed by a SIMD microprocessor in a single time is 96 pixels. In a case where no invalid pixels are created on either end of the pixel data array, all of the 480 pixels in the image data can be processed by having the SIMD microprocessor repeat a process five times. FIG. 11 shows an example where invalid pixels are created on both ends of the pixel data array. In a case where 16 pixels are invalid on each end, the valid pixels area is 64 pixels. Therefore, in order to process all of the 480 pixels, the SIMD microprocessor is required to repeat a process eight times.

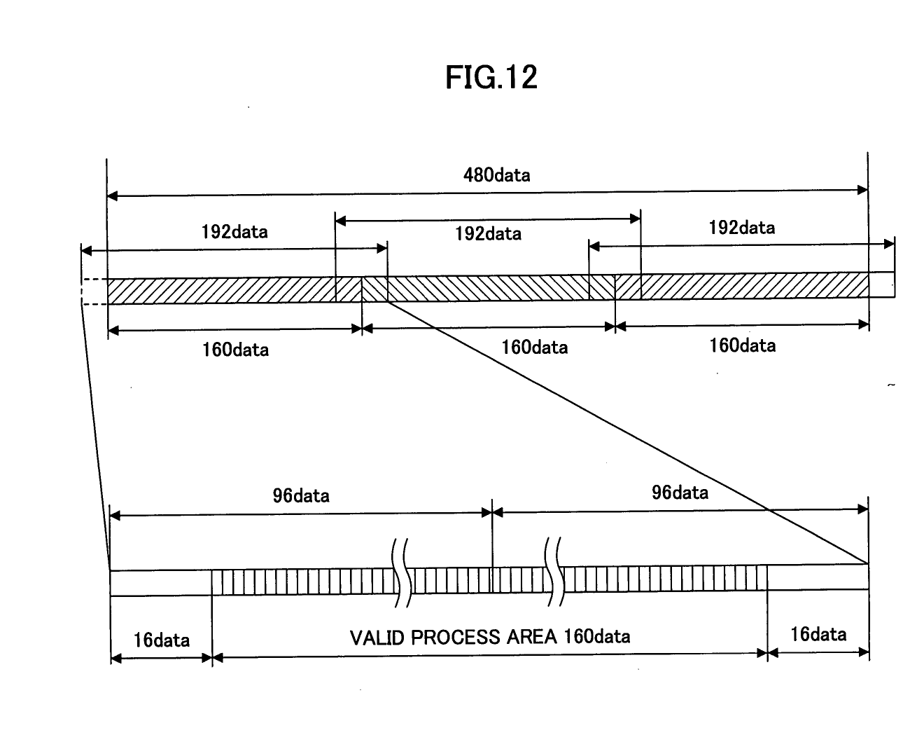

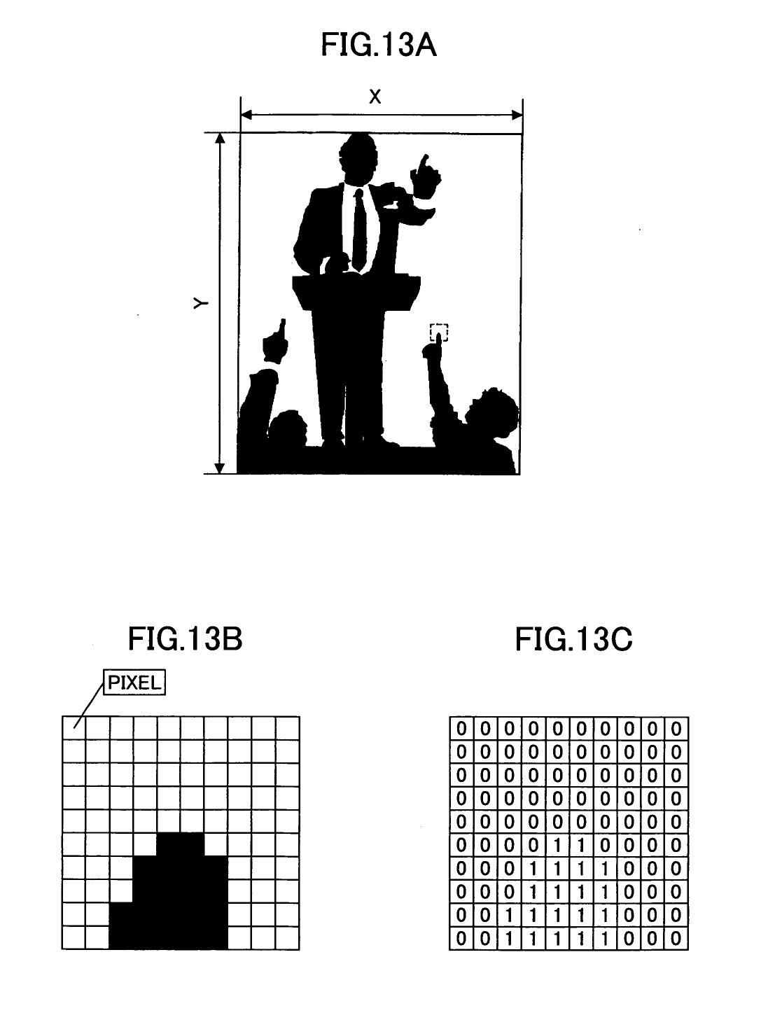

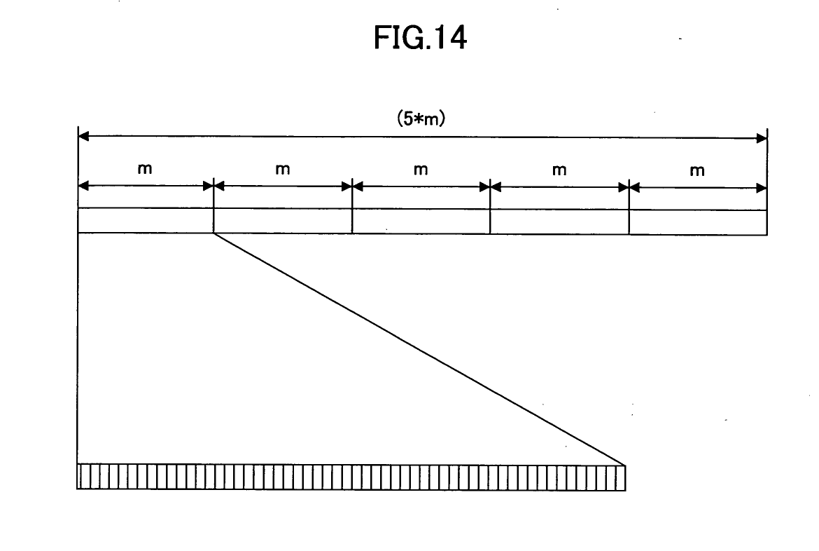

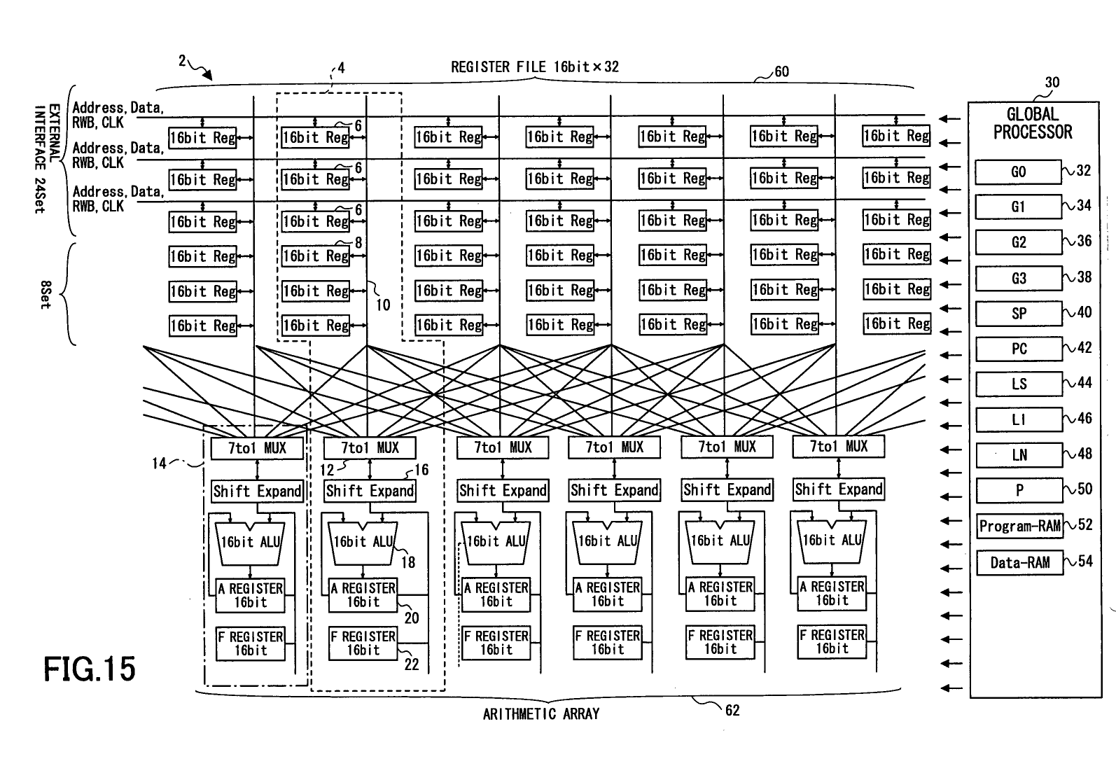

In a case where the throughput (processing performance) is doubled and the target process pixels are consecutively arranged on the same line (i.e. a case where the alignment pattern shown in FIG. 5 or FIG. 6 is used), the number of pixels that can be processed in a single time is doubled from 96 pixels to 192 pixels (See FIG. 12). If 16 pixels (invalid pixels) are subtracted from each end, the number of valid pixels is 160 pixels. Accordingly, as shown in FIG. 12, in order to process all of the 480 pixels, the SIMD microprocessor is required to repeat a process only three times. Therefore, in this case, the throughput (processing performance) can be two times or more higher.

In a case of using the fourth alignment pattern (FIG. 8) with the SIMD microprocessor according to the fourth embodiment of the present invention, two lines in a single image data item can be processed at the same time. Generally, in image processing, the same data process is repeated on all lines. However, in a filtering process, for example, the coefficients may be different in each line, to thereby require switching of lines for executing magnification control by bit shifting. Thus, switching the lines to be controlled can be achieved with the fourth embodiment of the present invention.

In a case of using the fifth alignment pattern (FIG. 9) with the SIMD microprocessor according to the fourth embodiment of the present invention, plural image data items of same size can be processed in parallel. Generally, in color image processing, an RGB method or a CMYK method, for example, is employed, in which image data are fabricated in correspondence with respective three to four colors. Accordingly, three to four image data items having the same size are created for a single image. In such color image processing, coefficients are set for image data item of each color. Thus, switching the colors to be controlled can be achieved with the fourth embodiment of the present invention.

Further, the present invention is not limited to these embodiments, but variations and modifications may be made without departing from the scope of the present invention.

The present application is based on Japanese Priority Application No. 2005-080548 filed on Mar. 18, 2005, with the Japanese Patent Office, the entire contents of which are hereby incorporated by reference.

What is claimed is:

1. A SIMD microprocessor including m processor elements, m being a natural number that is no less than 2, the SIMD microprocessor comprising:
an arithmetic part included in each processor element for processing a maximum of n data items in a single time by using n arithmetic circuits, n being a natural number that is no less than 2.

2. A SIMD microprocessor including m processor elements, m being a natural number that is no less than 2, each processor element including a plurality of registers for temporarily storing data, an arithmetic part, and a path for transferring data between the plural registers and the arithmetic part, the SIMD microprocessor comprising:
n arithmetic circuits in each arithmetic part for processing a maximum of n data items in a single time in each processor element, n being a natural number that is no less than 2;
wherein the m processor elements are arranged with a predetermined alignment, wherein the n arithmetic circuits are arranged in predetermined positions in each processor element;
wherein in a case of processing consecutive data items at the same time, the order for processing the data items with (m×n) arithmetic circuits is determined according to the predetermined positions of the arithmetic circuits in each processor element with reference to the predetermined alignment of the processor elements.

3. The SIMD microprocessor as claimed in claim 2, wherein the arithmetic circuit includes a data transfer path for transferring data to a register provided in the same processor element as the arithmetic circuit and to another register provided in a neighboring processor element, wherein the data transfer path transfers neighboring data in a consecutive data item to be processed at the same time.

4. A SIMD microprocessor including m processor elements, m being a natural number that is no less than 2, each processor element including a plurality of registers for temporarily storing data, an arithmetic part, and a path for transferring data between the plural registers and the arithmetic part, the SIMD microprocessor comprising:
n arithmetic circuits in each arithmetic part for processing a maximum of n data items in a single time in each processor element, n being a natural number that is no less than 2;
wherein the m processor elements are arranged with a predetermined alignment, wherein the n arithmetic circuits are arranged in predetermined positions in each processor element;
wherein in a case of processing consecutive data items at the same time, the order for processing the data items with (m×n) arithmetic circuits is determined according to the predetermined alignment of the processor elements with reference to the predetermined positions of the arithmetic circuits in each processor element.

5. The SIMD microprocessor as claimed in claim 4, wherein one arithmetic circuit includes a data transfer path for transferring data to a register provided in the same processor element as the arithmetic circuit and to another register provided in a neighboring processor element, wherein another arithmetic circuit provided in a processor element situated on one end of the predetermined alignment of processor elements includes a data transfer path for transferring data to yet another register provided in a processor element situated on the other end of the predetermined alignment of processor elements, wherein the data transfer paths transfer neighboring data in a consecutive data item to be processed at the same time.

6. The SIMD microprocessor as claimed in claim 4, wherein each arithmetic circuit includes a bit shift apparatus for setting different bit shift amounts in accordance with the predetermined positions of the arithmetic circuits in each processor element.

7. A method for processing data by using an SIMD microprocessor including m processor elements, m being a natural number that is no less than 2, each processor element including a plurality of registers for temporarily storing data, an arithmetic part, and a path for transferring data between the plural registers and the arithmetic part, the arithmetic part including n arithmetic circuits for processing a maximum of n data items in a single time in the arithmetic part, n being a natural number that is no less than 2, the method comprising the steps of:
determining the alignment for arranging the m processor elements;
determining the positions for arranging the n arithmetic circuits in each processor element; and
processing consecutive data items at the same time by determining the order for processing the data items with (m×n) arithmetic circuits according to the predetermined positions of the n arithmetic circuits in each processor element with reference to the predetermined alignment of the processor elements.

8. The data processing method as claimed in claim 7, further comprising a step of:
transferring data to a register provided in the same processor element as the arithmetic circuit and to another register provided in a neighboring processor element via a data transfer path provided in the arithmetic circuit, wherein the data transfer path transfers neighboring data in a consecutive data item to be processed at the same time.

9. A method for processing data by using a SIMD microprocessor including m processor elements, m being a natural number that is no less than 2, each processor element including a plurality of registers for temporarily storing data, an arithmetic part, and a path for transferring data between the plural registers and the arithmetic part, the arithmetic part including n arithmetic circuits for processing a maximum of n data items in a single time in the arithmetic part, n being a natural number that is no less than 2, the method comprising the steps of:
determining the alignment for arranging the m processor elements;
determining the positions for arranging the n arithmetic circuits in each processor element; and
processing consecutive data items at the same time by determining the order for processing the data items with (m×n) arithmetic circuits according to the predetermined alignment of the processor elements with reference to the predetermined positions of the n arithmetic circuits in each processor element.

10. The data processing method as claimed in claim 9, further comprising the steps of:
transferring data to a register provided in the same processor element as the arithmetic circuit and to another register provided in a neighboring processor element via a data transfer path provided in one arithmetic circuit; and
transferring data to yet another register provided in a processor element situated on one end of the predetermined alignment of processor elements via a data transfer path provided in another arithmetic circuit provided in a processor element situated on the other end of the predetermined alignment of processor elements, wherein the data transfer paths transfer neighboring data in a consecutive data item to be processed at the same time.

11. The data processing method as claimed in claim 9, further comprising a step of:
setting different bit shift amounts in accordance with the predetermined positions of the arithmetic circuits in each processor element by using a bit shift apparatus.
